(19) United States
(12) Patent Application Publication
(10) Pub. No.: US 2026/0050973 A1
(43) Pub. Date: Feb. 19, 2026

(54) NETWORK SYNCHRONIZATION ARCHITECTURE FOR LINKING INSTRUMENTS

(71) Applicant: Wells Fargo Bank, N.A., San Francisco, CA (US)

(72) Inventor: Stephen Paulos, San Francisco, CA (US)

(21) Appl. No.: 18/807,748

(22) Filed: Aug. 16, 2024

(51) Int. Cl. G06Q 40/04; G06Q 30/0601

(52) U.S. Cl. CPC G06Q 40/04; G06Q 30/0641

(57) ABSTRACT

Systems, computer-readable media, devices, and methods for linking instruments. One method includes receiving exchange data including an exchange amount for an exchange initiated by a linked payment instrument corresponding to multiple linked merchants of a provider. The method can include generating a recognition unit for the exchange amount including an allocation state and determining a first and second exchange rate based on a first and second exchange rate parameter. The recognition unit can be agnostic for a first or second linked merchant. The method can include generating content items or actionable elements corresponding to the exchange rates and providing the items/elements to a GUI of the provider’s mobile application, and receiving a selection of the items/elements. In response to the selection, the method can include allocating the recognition unit to the first or second linked merchant and updating the allocation state indicating the allocation.

### TECHNICAL FIELD

The present disclosure relates to the field of providing interoperability between and among accounts of users across separate entities. More particularly, the aspects and embodiments of the present disclosure relate to linking or synchronizing multiple computing platforms to facilitate, for example, synchronization of instruments maintained by separate enterprise computing systems.

### BACKGROUND

In a networked environment such as the internet, users and entities such as individuals, providers, and merchants regularly transact and exchange data. A user can earn points based on transactions between the user and a merchant, and the points can be redeemable with that merchant. The points may be issued by a service provider computing system of a service provider facilitating the transaction. However, the points are not redeemable outside of a merchant environment. That is, the points are not spendable or otherwise redeemable at one or more additional merchants or with the service provider due to various technical barriers.

### SUMMARY

One embodiment relates to a method for linking instruments. In some embodiments, the method can include receiving, by one or more processing circuits, exchange data including an exchange amount for an exchange initiated by a linked payment instrument. The linked payment instrument can correspond to a plurality of linked merchants of a provider. The method can further include generating, by the one or more processing circuits, at least one recognition unit corresponding with the exchange amount, the at least one recognition unit comprising an allocation state. The method can include determining a first exchange rate for the at least one recognition unit based on at least one first exchange parameter of a first linked merchant or group of the plurality of linked merchants and the exchange amount, and determining a second exchange rate for the at least one recognition unit based on at least one second exchange parameter of a second linked merchant or group of the plurality of linked merchants and the exchange amount. In some embodiments, the at least one recognition unit can be agnostic for at least the first linked merchant and the second linked merchant. In some embodiments, the method can further include generating, by the one or more processing circuits, one or more content items or one or more actionable elements corresponding to the first exchange rate and to the second exchange rate. The method can include providing, by the one or more processing circuits, the one or more content items or the one or more actionable elements to a graphical user interface (GUI) of a provider mobile application of the provider. In some embodiments, the method can include receiving, by the one or more processing circuits, a selection of the one or more content items or the one or more actionable elements corresponding to the first exchange rate or to the second exchange rate. In response to receiving the selection corresponding to the first exchange rate, the method can further include allocating, by the one or more processing circuits, the at least one recognition unit to the first linked merchant. In response to receiving the selection corresponding to the second exchange rate, the method can further include allocating, by the one or more processing circuits, the at least one recognition unit to the second linked merchant. The method can further include updating, by the one or more processing circuits, the allocation state of the at least one recognition unit indicating the at least one recognition unit is allocated to the one or more merchants of the plurality of linked merchants. In some embodiments, the allocation of the at least one recognition unit can be agnostic of a third linked merchant of the plurality of linked merchants where the exchange is initiated.

Another embodiment relates to a system for linking instruments. The system can include one or more processing circuits configured to receive exchange data including an exchange amount for an exchange initiated by a linked payment instrument. In some embodiments, the linked payment instrument corresponds to a plurality of linked merchants of a provider. The one or more processing circuits can be further configured to generate at least one recognition unit corresponding with the exchange amount, the at least one recognition including an allocation state. The one or more processing circuits can be further configured to determine a first exchange rate for the at least one recognition unit based on at least one first exchange parameter of a first linked merchant or group of the plurality of linked merchants, and determine a second exchange rate for the at least one recognition unit based on at least one second exchange parameter of a second linked merchant or group of the plurality of linked merchants and the exchange amount. In some embodiments, the at least one recognition unit can be agnostic for at least the first linked merchant and the second linked merchant. The one or more processing circuits can be further configured to generate one or more content items or one or more actionable elements corresponding to the first exchange rate and to the second exchange rate, provide the one or more content items or the one or more actionable elements to a graphical user interface (GUI) of a provider mobile application of the provider, and receive a selection of the one or more content items or the one or more actionable elements corresponding to the first exchange rate or to the second exchange rate. In response to receiving the selection corresponding to the first exchange rate, the one or more processing circuits can be further configured to allocate the at least one recognition unit to the first linked merchant. In response to receiving the selection corresponding to the second exchange rate, the one or more processing circuits can be further configured to allocate the at least one recognition unit to the second linked merchant. The one or more processing circuits can be further configured to update the allocation state of the at least one recognition unit indicating the at least one recognition unit is allocated to the one or more merchants of the plurality of linked merchants.

Still another embodiment relates to one or more non-transitory computer-readable media (CRM) having instructions stored thereon that, when executed by one or more processing circuits, cause the one or more processing circuits to receive exchange data including an exchange amount for an exchange initiated by a linked payment instrument. The linked payment instrument can correspond to a plurality of linked merchants of a provider. In some embodiments, the instructions can cause the one or more processing circuits to generate at least one recognition unit corresponding with the exchange amount, the at least one recognition unit including an allocation state. The instructions can cause the one or more processing circuits to determine a first exchange rate for the at least one recognition unit based on at least one first exchange parameter of a first linked merchant or group of the plurality of linked merchants and the exchange amount, and determine a second exchange rate for the at least one recognition unit based on at least one second exchange parameter of a second linked merchant or group of the plurality of linked merchants and the exchange amount. In some embodiments, the at least one recognition unit can be agnostic for at least the first linked merchant and the second linked merchant. In some embodiments, the instructions can further cause the one or more processing circuits to generate one or more content items or one or more actionable elements corresponding to the first exchange rate and to the second exchange rate and provide the one or more content items or the one or more actionable elements to a graphical user interface (GUI) of a provider mobile application of the provider. The instructions can further cause the one or more processing circuits to receive a selection of the one or more content items or the one or more actionable elements corresponding to the first exchange rate or to the second exchange rate. In response to receiving the selection of the first exchange rate, the instructions can further cause the one or more processing circuits to allocate the at least one recognition unit to the first linked merchant. In response to receiving the selection of the second exchange rate, the instructions can further cause the one or more processing circuits to allocate the at least one recognition unit to the second linked merchant. The one or more processing circuits can be further configured to update the allocation state of the at least one recognition unit indicating the at least one recognition unit is allocated to the one or more merchants of the plurality of linked merchants.

Numerous specific details are provided to impart a thorough understanding of embodiments of the subject matter of the present disclosure. The described features of the subject matter of the present disclosure can be combined in any suitable manner in one or more embodiments and/or implementations. In this regard, one or more features of an aspect of the embodiments can be combined with one or more features of a different aspect of the embodiments. Moreover, additional features can be recognized in certain embodiments and/or implementations that cannot be present in all embodiments or implementations.

### BRIEF DESCRIPTION OF THE FIGURES

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

FIG. 1 is a block diagram depicting an example of a computing environment within an credit system, according to some arrangements;

FIG. 2 is a flowchart for a method for linking instruments, according to some arrangements;

FIG. 3 is a block diagram illustrating an example computing system suitable for use in the various arrangements described herein; and

FIGS. 4A-4B are example graphical user interfaces depicting an application user interface, according to some arrangements.

It will be recognized that some or all the Figures are schematic representations for purposes of illustration. The Figures are provided for the purpose of illustrating one or more embodiments with the explicit understanding that they will not be used to limit the scope or the meaning of the claims.

### DETAILED DESCRIPTION

Referring generally to the Figures, the systems, apparatuses, and methods disclosed herein relate to integrating data and facilitating system interoperability. In many systems, determining and allocating recognition units (e.g., rewards or credits) for transactions or other exchanges across different merchants or providers introduces technical inefficiencies. For example, a user can earn recognition units based on exchanges (e.g., purchases) between the user and a merchant, and the recognition units can be redeemable with the merchant (e.g., for purchase credit). However, these recognition units may not be agnostic. That is, the recognition units earned based on exchanges between the user and the merchant may not be redeemable outside of a merchant-specific environment (e.g., recognition units may not be earned agnostically such that these units are transferrable to additional merchants or to a provider). In other systems, users often navigate multiple interfaces to view and select different exchange rates, verify transaction details, and access various services (e.g., loading separate applications, accessing multiple web portals, etc.). Users may not know the most favorable exchange rates or be able to track allocated rewards credits, which can lead to suboptimal rewards conversion, missed notifications, and increased latency in transaction processing. Further, the computational demand from loading multiple applications and web interfaces on a single device when managing transaction data or rewards credits imposes a resource load on devices with limited processing power and memory, such as mobile devices, resulting in degraded performance and increased battery consumption. These inefficiencies can degrade user experience by increasing the computational load and memory usage of the device, leading to slower performance (e.g., longer loading times) and quicker battery drain. Accordingly, there is a need for systems and methods that facilitate transaction management, determine and apply the most favorable exchange rates, and integrate functionality into a single or limited number of interfaces, thereby enhancing system interoperability, improving computational efficiency, reducing memory usage, and minimizing resource load on devices.

The systems, computer-readable media, devices, and methods described herein provide a synchronization architecture that provides technical advantages by improving the synchronizing and allocation of rewards credits across multiple merchant computing platforms using a linked payment instrument (sometimes referred to as an “agnostic payment card,” “agnostic transaction card,” or “agnostic payment instrument”). One technical benefit of the synchronization architecture is the reduction in computational load and memory usage on various computing devices, such as mobile devices. By consolidating rewards synchronization tasks into a single interface, users can allocate rewards credits to different merchants without loading and switching between multiple applications and web portals, thereby reducing the processing power and memory utilized when synchronizing rewards and transactions. That is, consolidating rewards synchronization execution into a unified interface reduces the need to load and manage multiple applications simultaneously, thus decreasing the overall processing power required. Additionally, rewards synchronization reduces redundant data storage and handling operations, leading to lower memory usage on the device. As described herein, this consolidation can minimize the strain on computing device resources, leading to faster performance and extended battery life. Further, the determination of exchange rates and the integration of rewards information into a unified interface improves data consistency and accuracy by reducing the likelihood of errors and discrepancies that can arise from fragmented rewards synchronization. The disclosed systems, computer-readable media, devices, and methods provide a technically improved graphical user interface while technologically improving the computational efficiency and resource management of resource-limited devices (e.g., mobile phones).

The systems, computer-readable media, devices, and methods described herein also provide technical improvements by enhancing data security and privacy in the allocation of rewards credits across multiple merchants. By utilizing the synchronization architecture that provide secure and/or centralized systems for synchronizing rewards data, users can access services and products without repeatedly entering sensitive login credentials across various platforms. This minimizes the exposure of sensitive data, such as usernames, passwords, and account details, thereby lowering the risk of interception and unauthorized access. Additionally, the systems, computer-readable media, and devices can continuously (e.g., real-time, near real-time, periodically) verify authorization statuses through secure data communications links to process sensitive information in a controlled and protected environment. The use of secure data communications links can reduce the attack surface for potential cyber threats (e.g., malware, spyware, phishing, DDoS, etc.) and strengthen the overall security posture of the system, improving data security for the user, the provider, and the merchants. Moreover, the consolidation of rewards synchronization processes into a unified, secure interface can facilitate the implementation of security measures, such as encryption and multi-factor authentication, further safeguarding user data. Secure data communication links between the provider and platform systems can also be used to facilitate the exchange of sensitive information, such as transaction data and reward criteria, and the use of such links can further reduce the risk of data breaches. These technical improvements contribute to a more secure and resilient system for synchronizing rewards credits and transactions that protect against data breaches and enhance user privacy.

The systems, computer-readable media, devices, and methods described herein offer further technical benefits by improving the process of synchronization and real-time data processing. By centralizing the retrieval and analysis of data across multiple sources, the implementations can relatively accurately analyze and determine user credits or reward eligibility and calculate or determine credits or reward amounts without manual intervention, which can reduce the processing time and computational resources required to facilitate reward programs or track rewards, particularly on mobile devices with limited capabilities. Further, the aspects and embodiments described herein can consolidate information into a unified interface so users can access data without navigating or launching multiple applications, reducing memory usage on user devices. Additionally, the disclosed systems, computer-readable media, devices, and methods can identify linked and unlinked data between the provider and sources and further notify users of status updates (e.g., user reward status), thereby improving data transmission and integrity by assisting users in avoiding missed and/or unclaimed updates (e.g., rewards). The systems, computer-readable media, devices, and methods disclosed herein thus improve system interoperability, provide accurate information, and reduce the computational load on both the provider and user devices.

The systems, computer-readable media, devices, and methods described herein offer technical benefits by enhancing graphical user interfaces (GUIs) for data visualization and interactions. By integrating data visualization techniques, the implementations provide consolidated information from multiple sources in a user-friendly and intuitive manner. Further, the system facilitates access and understanding of user data and eligibility by providing users a unified application to link multiple accounts (e.g., without the user navigating through multiple applications or websites to access such information). The systems, computer-readable media, devices and methods can further utilize dynamic UI components that update in real-time to reflect recent exchange data and reward calculations, thereby providing users with immediate or substantially immediate feedback. Additionally, the systems, computer-readable media, devices and methods can be configured to provide optimal performance and usability across various devices, including smartphones and tablets with limited processing power, when synchronizing linked instruments. Thus, the systems and methods disclosed herein further improve system interoperability, user interaction processes, and facilitate accurate access to information through GUIs.

According to the present disclosure, systems, computer-readable media, devices, and methods are provided to issue a transaction card (e.g., a credit card) that earns an agnostic currency or agnostic rewards (i.e., currency/rewards that are not specific to a single merchant). Generally, the disclosed systems, computer-readable media, devices, and methods provide a transaction card that earns rewards applicable to any linked partner accounts (e.g., merchant). An embodiment of one system operates by partnering with merchants in a rewards transfer program. In one arrangement, the synced or linked partners may be static in nature, such that the accrued rewards from the use of the transaction card are only usable with those original linked partners. In another arrangement, the linked partners may change over time (e.g., being dynamic). The linked partners may be predefined (e.g., applicable to merchant A, merchant B, and merchant C) or selectable by the user (e.g., the user may select merchant A and merchant C only). In some arrangements, choosing the linked partners may affect other aspects of the transaction card (e.g., APR and redemption rates for the linked merchants, rewards accumulation, etc.). The system may provide a user interface (UI) that depicts redemption rates in real-time to provide users the best redemption merchant or partner at a given moment. In some arrangements, the system may sell the currency to merchant partners to incentivize the merchant partners’ customers to shop at the merchant partner. For example, the currency can be sold to a merchant, who can then transfer it to the merchant’s customers as rewards, which can then be redeemed back to the financial institution for statement credit. In some embodiments, the disclosed systems, computer-readable media, devices, and methods may provide a transaction card or linked payment instrument that is integrated with distributed ledger technology (“DLT”), where a blockchain records the transactions of the sold currency, providing a chain of ownership and facilitating the tracking of settlement. In some embodiments, the agnostic currency and rewards can include provider currency on a blockchain and can be converted to any linked partner accounts after earning through spending on the agnostic card. The systems, computer-readable media, devices, and methods described here generally facilitate users managing and accumulating rewards through various merchants, including merchants without their own rewards programs, through earning on a linked transaction card.

An example may be described as follows. A customer, John Doe, uses a transaction card (e.g., credit card) issued by his financial institution to make purchases at various retailers. John’s card is linked to several partner merchants, such as a grocery store, a bookstore, and a coffee shop. A provider computing system receives exchange data from John’s transactions (e.g., from merchant systems, mobile devices, etc.) and identifies an exchange amount and location (e.g., purchase price of $20 at a coffee shop) for each purchase. The system then generates recognition units (e.g., rewards points, transaction card points, etc.) based on the exchange amount and an allocation state (e.g., 20 unallocated (financial institution) points). Once the recognition units are generated, they are distributed to John’s corresponding financial institution account, and may be added to a balance of pre-existing recognition units (e.g., 20 unallocated points may be added to a current balance of 50 points to result in a total of 70 points).

For each linked merchant, the system can then determine or calculate a corresponding exchange rate (e.g., rewards conversion rate) between the financial institution recognition units and a merchant recognition unit (e.g., merchant reward points). This may be executed based on predefined exchange parameters for each linked merchant (e.g., based on John’s past spending with the grocery store, whether John is a high-tier member of the rewards program, etc.). For instance, the system calculates a first exchange rate for the grocery store (e.g., 1 financial institution point = 2 grocery store points) and a second exchange rate for the bookstore (e.g., 1 financial institution point = 1.5 bookstore points). The mobile banking app on John’s phone, provided by his financial institution, can display a message: “You have earned rewards that can be redeemed at your linked merchants. Choose a merchant to see the best redemption rates.” The message can include actionable elements (e.g., user interface elements) with buttons for each merchant indicating the respective exchange rates. John taps on the button for the grocery store, and the app displays the current redemption rate alongside the redemption rate for the bookstore. Seeing that the grocery store offers a higher redemption rate (e.g., 1 financial institution point = 2 grocery store points), John selects the grocery store. The system can further establish a data communications link with the grocery store’s computing system to facilitate the redemption process. Upon receiving John’s selection, the system can allocate the recognition units to the grocery store using the established link and update the allocation state of the units (e.g., updating stored data corresponding to the rewards points from “unallocated” to “allocated” on a back-end provider or merchant system). The graphical user interface (GUI) on the mobile banking app can then update to indicate that John’s rewards have been successfully redeemed at the grocery store, showing the converted rewards points and the updated balance (e.g., 20 financial institution points converted at the first exchange rate of 1 financial institution point = 2 grocery store points, for a total of 40 allocated grocery store points/recognition units). The transaction card used by John can be described as an agnostic transaction card because the card facilitates earning rewards through spending with one merchant (e.g., the bookstore) redeemable with another merchant (e.g., the grocery store).

As used herein, an “exchange” refers to a transaction or interaction involving the transfer of value between two or more parties. For example, exchanges can include, but are not limited to, financial transactions such as payments, refunds, etc. The exchanges may be effectuated via a mobile application, a credit card, etc. and occur at various locations, such as at a merchant’s point of sale (e.g., credit card transactions, mobile wallet payments, etc.). As described herein, an “exchange” can refer to the accrual and/or redemption of recognition points, loyalty points, rewards, and/or membership benefits (e.g., points earned from a purchase, membership tier upgrades, etc.). Generally, performing or facilitating an exchange can include an initiation of the transaction (e.g., by the user from spending at various places, by a merchant in response to a user achieving a predefined points balance, etc.), a validation and/or authorization of the transaction by the provider and/or merchant, and an update of account information to reflect the completed transaction (e.g., a modification of a user’s account or other data based on redeeming or converting rewards). In another example, an “exchange” can include, but is not limited to, a crediting or allocation of a sum or quantity of exchange rewards (e.g., 20 points) to a user (e.g., to a user’s merchant account), a conversion of rewards or benefits of a first type to rewards or benefits of a second type (e.g., from rewards redeemable with a first merchant to a rewards redeemable with a second merchant), and so on.

It should be understood that while the present disclosure is explained mainly in regard to providing and managing a transaction card that earns agnostic rewards, such a description is not meant to be limiting. The principles described herein may be applicable to various other types of data management systems and synchronization methods across various industries and applications. All such variations are intended to fall within the scope of the present disclosure.

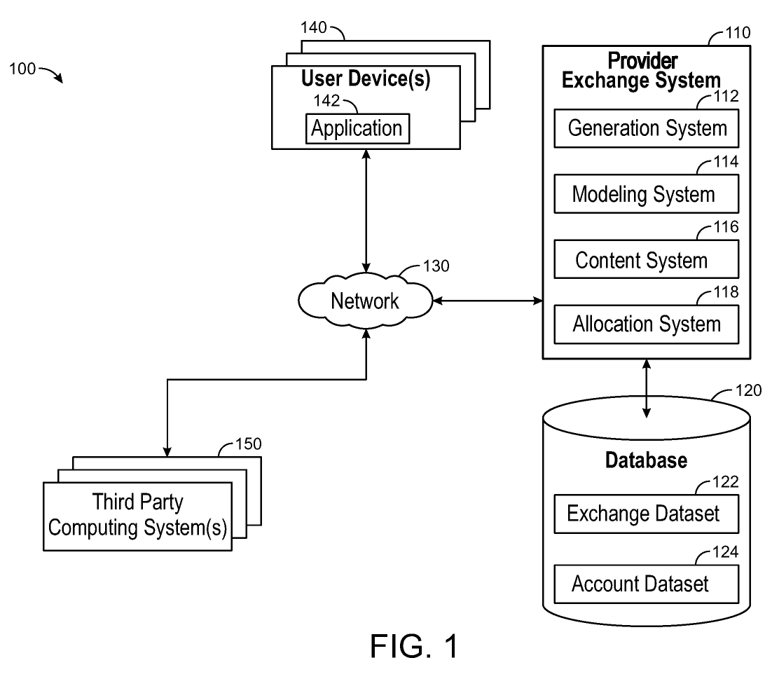

Referring now to FIG. 1, a block diagram depicting an example of a computing environment 100 with a provider exchange system 110 (collectively referred to herein as the “synchronization architecture” or the “provider exchange system”) is shown, according to some arrangements. As shown, the environment 100 includes the provider exchange system 110, a database 120, a network 130, one or more user device(s) 140, and one or more third party computing system(s) 150. The provider exchange system 110 can include a generation system 112, a modeling system 114, a content system 116, and an allocation system 118. The provider exchange system 110 can be communicatively coupled or linked to the database 120, and the database 120 can include an exchange dataset 122 and an account dataset 124. The user device(s) 140 can include an application 142 (also referred to herein as the provider application 142 or the provider mobile application 142). Although the various computing elements of FIG. 1 can be described in the singular form below (e.g., network 130, user device 140, etc.), it should be understood that the computing environment 100 can include two or more of any device/system described herein (e.g., two or more network(s) 130, two or more user device(s) 140, etc.).

In various arrangements, components of the environment 100 communicate over network 130. Network 130 can include computer networks such as the Internet, local, wide, metro or other area networks, intranets, satellite networks, other computer networks such as voice or data mobile phone communication networks, combinations thereof, or any other type of electronic communications network. Network 130 can include or constitute a display network. In various implementations, network 130 facilitates secure communication between components of system 100. As a non-limiting example, network 130 can implement transport layer security (TLS), secure sockets layer (SSL), hypertext transfer protocol secure (HTTPS), and/or any other secure communication protocol.

In some arrangements, network 130 can be composed of various network devices (nodes) communicatively linked to form one or more data communication paths between participating devices. The network 130 can facilitate communication between the various nodes, such as the provider exchange system 110, database 120, one or more user device(s) 140, and one or more third party computing system(s) 150 (e.g., using an OSI layer-4 transport protocol such as the User Datagram Protocol (UDP), the Transmission Control Protocol (TCP), Stream Control Transmission Protocol (SCTP), etc.). Each networked device can include at least one network interface for receiving and/or transmitting data, typically as one or more data packets. An illustrative network 130 is the Internet (however, other networks can be used). Network 130 can be an autonomous system (AS), i.e., a network that is operated under a consistent unified routing policy (or at least appears to from outside the AS network) and is generally managed by a single administrative entity (e.g., a system operator, administrator, or administrative group).

The provider exchange system 110 can be a computing system including at least one processor and memory, such as a computing device having at least one processing circuit configured to execute instructions stored in a memory device to perform one or more operations described herein. The provider exchange system 110 may be owned by, or otherwise associated with, a provider (e.g., provider institution). For example, the provider institution may be a financial institution, such as commercial or private banks, credit unions, investment brokerages, and so on. The provider institution may also include any commercial entity capable of maintaining charge accounts, including retailers, vendors, service providers, and the like. In some embodiments, the provider exchange system 110 may also include a card issuer and a card issuer computing system. The provider exchange system 110 may also be configured to manage charge accounts and authorize transactions involving debits from charge accounts associated with customers. In one example, the provider exchange system 110 can identify user accounts with third parties and analyze transactions (e.g., exchanges) with these third parties to identify accumulated credits and/or rewards opportunities. That is, the provider exchange system 110 can automatically perform account-related tasks for the provider, such as providing agnostic transaction cards, monitoring exchange histories, determining eligible transactions, and linking various user data or accounts, as further described herein.

The provider exchange system 110 may be owned by, or otherwise associated with, a provider, which is also referred to as a provider institution. The provider institution may be a provider of goods and/or services. In one embodiment and as shown, the provider institution may be a financial institution, such as a commercial or private bank, credit union, investment brokerage, and so on. The provider institution may maintain one or more accounts for individual persons and/or entities. The provider exchange system 110 may also be configured to manage accounts and authorize transactions involving withdrawals and/or deposits from accounts (e.g., a checking account) associated with customers. In one example, the provider exchange system 110 can identify user accounts with third parties and analyze transactions (e.g., exchanges) with these third parties to identify rewards opportunities. That is, the provider exchange system 110 can automatically perform account-related tasks for the provider institution, such as monitoring exchange histories, determining eligible transactions, and linking various third-party user accounts, as further described herein.

In the example shown, the provider exchange system 110 includes a plurality of sub-processing systems, shown as the generation system 112, modeling system 114, content system 116, and allocation system 118 for synchronizing and linking payment instruments (e.g., for providing an agnostic rewards credit card). In some arrangements, the provider exchange system 110 and/or included sub-systems (e.g., generation system 112, modeling system 114, etc.) can include at least one processing system or device, such as a computing device having at least one processing circuit configured to execute instructions stored in a memory device to perform one or more operations described herein. The processing circuit can include a processor, such as a microprocessor, an application specific integrated circuit (ASIC), a field-programmable gate array (FPGA), etc., or combinations thereof. The processing circuit can include a memory, and the memory can include, but is not limited to, electronic, optical, magnetic, or any other storage or transmission device capable of providing processor(s) with program instructions. The instructions can include code from any suitable computer programming language such as, but not limited to, ActionScript®, C, C++, C#, HTML, Java®, JavaScript®, Perl®, Python®, Visual Basic®, and XML.

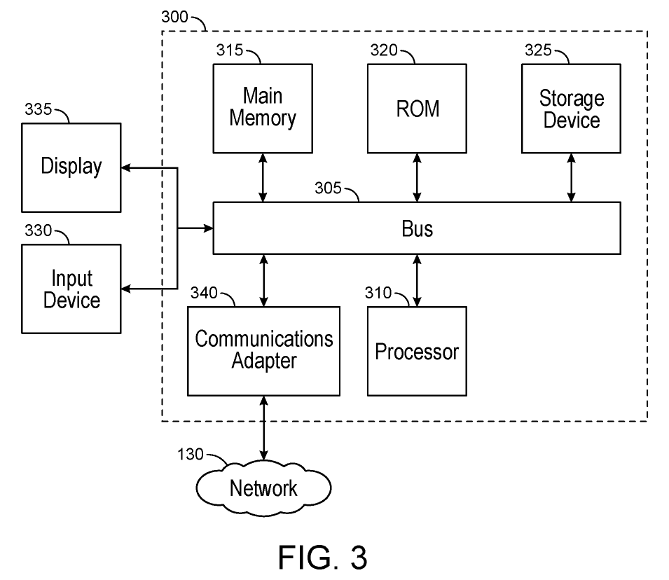

In some arrangements, the provider exchange system 110, database 120, user device 140, and/or third party computing systems 150 can include the computing device described in FIG. 3, which can be used to provide linked instruments (e.g., an agnostic transaction card). In other arrangements, the provider exchange system 110 may be a server, distributed processing cluster, cloud processing system, or any other computing device or system. The provider exchange system 110 can include or execute at least one computer program or at least one script. In some implementations, provider exchange system 110 includes combinations of software and hardware, such as one or more processors configured to execute one or more scripts. For example, the provider exchange system 110 can include one or more processing circuits (e.g., a processing circuit) including a processor and memory, and the memory can have instructions stored thereon that, when executed by the processor, cause the processing circuit to perform the various operations described herein. The operations described herein can be implemented using software, hardware, or a combination thereof. As mentioned above and herein, the processor(s) included in the processing circuit(s) of the provider exchange system 110 can include a microprocessor, ASIC, FPGA, etc., or combinations thereof, or can include a multi-core processor or an array of processors. The memory included in the processing circuit of the provider exchange system 110 can include, but is not limited to, electronic, optical, magnetic, or any other storage devices capable of providing a processor or processing circuit with program instructions. For example, the memory can include a floppy disk, CD-ROM, DVD, magnetic disk, memory chip, ROM, RAM, EEPROM, EPROM, flash memory, optical media, or any other suitable memory from which processor(s) can read instructions (e.g., one or more non-transitory CRM).

In some arrangements, in addition to the processing circuit(s), the provider exchange system 110 can include and/or be communicatively coupled to one or more databases (e.g., database 120). The databases may be structured as a data repository that is configured to store data, such as exchange history data or account data. For example, the database 120 can include data structures for storing information such as, but not limited to, exchange data and/or exchange information (e.g., exchange amount or transaction amount, exchange date or transaction date, exchange rewards data, merchant exchange data, etc.), account data and/or account information (e.g., linked accounts, unlinked accounts, existing/new accounts with providers/merchants, lists of accounts, account credentials including merchant usernames and merchant passcodes, etc.), recognition unit data or rewards data/information (e.g., eligible exchanges or transactions, merchant parameters such as exchange rewards rate, exchange rewards totals, calculated rewards, etc.), and/or other data or information. The database 120 can be part of the provider exchange system 110, or a separate component that the provider exchange system 110 or the user device 140 can access via the network 130. The database 120 can also be distributed throughout environment 100. For example, the database 120 can include multiple databases associated with the provider exchange system 110, a client device (E.g., user device 140), or both. Database 120 can include one or more storage mediums. The storage mediums can include, but are not limited to, magnetic storage, optical storage, flash storage, and/or RAM. In some arrangements, the provider exchange system 110 can implement or facilitate various APIs to perform database functions (i.e., managing, synchronizing, or linking data stored in database 120). The APIs can be but are not limited to SQL, ODBC, JDBC, NOSQL and/or any other data storage and manipulation API.

In some arrangements, the database 120 can include an exchange dataset 122 and an account dataset 124. The exchange dataset 122 can include data/information, referred to as exchange history data that provides an indication of a list of exchanges (e.g., transactions), exchange information (e.g., transaction or exchange date, merchant, exchange amount, etc.), and various additional data related to exchanges between one or more of a provider, merchant, and user. In some arrangements, the provider exchange system 110 can access the exchange dataset 122 of the database 120 to determine an exchange with unallocated recognition units (e.g., determining an eligible transaction for redeeming rewards). Further, the provider exchange system 110 can communicate with the database 120 (e.g., locally or via the network 130, etc.) to update stored information included in the exchange dataset 122 by, for example, updating data stored in exchange dataset 122 in response to identifying an allocation or other update to a recognition unit. For example, the provider exchange system 110 can update an allocation state associated with an exchange stored in dataset 122 in response to user input.

In some arrangements, the account dataset 124 may include similar features and/or functionality as described regarding the exchange dataset 122, but may include account information (e.g., account history data, lists of linked or unlinked accounts, etc.). The account information can refer to accounts of a user with the provider (or provider account). For example, a provider account may refer to an account held by the user with the provider (e.g., entity) that synchronizes exchanges and rewards across multiple merchants. As mentioned above, in the example shown, the provider may provide one or more financial products or services and, as such, the accounts (also referred to as provider accounts or user accounts with the provider), may include but are not limited to checking accounts, savings accounts, money market accounts, demand deposit accounts, certificates of deposit (CDs), individual retirement accounts (IRAs), brokerage accounts, credit card accounts, mortgage accounts, personal loan accounts, home equity lines of credit (HELOCs), educational savings accounts (e.g., 529 plans), etc. The account information may also be received from a third party computing system and include third-party accounts of a user with one or more third parties (e.g., merchant accounts, user accounts with a merchant, etc.), and include, but are not limited to, merchant rewards accounts, loyalty accounts, recognition programs, membership benefits programs, and/or travel and hospitality accounts (e.g., airline frequent flyer programs, hotel loyalty programs, vacation rental accounts, etc.). The third-party accounts of a user may also include, but are not limited to, utility accounts (e.g., electricity, gas, water, internet), healthcare accounts (e.g., patient portals, medical billing accounts), and/or insurance accounts (e.g., policyholder accounts, claim tracking accounts). The account information may also include various additional or alternative accounts involving one or more of the user, providers/financial institutions, merchants, or other entities, including but not limited to joint accounts, business accounts, investment accounts (e.g., brokerage accounts, mutual funds, pension plans), cryptocurrency wallets, and government benefit accounts (e.g., social security accounts, unemployment benefits). In one, in response to identifying an exchange between a user and a merchant, the provider exchange system 110 may query the account dataset 124, which may include a listing of linked or authenticated user accounts linked to the provider institution to determine if the user has authorized provider institution access to a user account with the particular merchant.

In some arrangements, the user device 140 (sometimes, depending on the configuration of the user device, the user device may be referred to herein as an “electronic device,” “mobile device,” or “mobile electronic device”) can be a computing device, personal computer (PC), desktop computer, laptop computer, smartphone, tablet, smart watch, smart sensor, or any other device configured to facilitate receiving, displaying, and interacting with content (e.g., applications, etc.) or data (e.g., recognition unit data, exchange parameters, allocation state updates or modifications, eligibility determinations, etc.). For example, user device 140 can be a cell phone configured to execute to application 142 to receive and display content and/or actionable elements and to receive user interaction with the content and/or actionable elements. User device 140 can also include an input/output circuit for communicating data over network 130.

In some arrangements, the user device(s) 140 can include an application 142 (also referred to as provider application 142, provider mobile application 142, etc.). In some arrangements, the user device(s) 140 can execute the application 142 or another software application (e.g., web browser, locally installed application, etc.) to link or synchronize user data, exchanges, and/or accounts between providers, merchants, and users. For example, the application 142 can be configured to retrieve content from other computing systems and devices over the network 130, such as an interface and/or dashboards (e.g., from the provider exchange system 110) for displaying exchange and/or account information to a user with the user device 140. Additionally or alternatively, application 142 can be a mobile application executed by mobile device 140. The application 142 can be a mobile application, such as a mobile banking application, which can be downloaded from an app store, pre-installed, or hard coded into the device’s memory.

In the example shown, the application 142 is provided and at least partly supported by the provider institution associated with the provider exchange system 110. Thus, the application 142 may be referred to as a provider application or provider mobile application. As mentioned herein, the provider institution may provide various financial products goods and/or services. As such, the provider institution mobile application 142 may provider various financial tools, such as transaction management, account monitoring, funds transfer, bill payments, and financial planning tools, etc. In some embodiments, the provider institution mobile application 142 can be a part of a mobile banking application associated with the provider institution or a separate application.

In some arrangements, the application 142 can include a collection of software development tools contained in a package (e.g., software development kit (SDK), application programming interface (API), integrated development environment (IDE), debugger, etc.). For example, application can include an application programming interface (API) or a debugger, or an SDK that includes an API, a debugger, an IDE, and so on. In some implementations, application 142 includes one or more libraries having functions that interface with a particular system software (e.g., iOS, Android, Linux, etc.). As a further example, application 142 can include a function configured to collect and report data (e.g., exchange data, account data, merchant data, device analytics, etc.), and a user can insert the function into the instructions of application 142 to cause the function to be called during specific actions of application 142 (e.g., in response to identifying an exchange).

The provider mobile application 142 can be installed and designed to run on smartphones, tablets, and other mobile devices. The provider mobile application 142 can include a client-side application that interacts with server-side components over the network. The mobile application 142 can be implemented using various programming languages and frameworks, such as Swift or Objective-C for iOS, and Kotlin or Java for Android. The provider mobile application 142 can be packaged and distributed through app stores. In some implementations, the provider mobile application 142 can include a presentation layer (UI/UX), a business logic layer, and a data layer. The presentation layer can handle user interactions and displays data using graphical user interface components. The business logic layer can process user inputs, manages application workflows, and enforces rules and policies. The data layer can manage data storage, retrieval, and synchronization with remote servers. The provider mobile application 142 can utilize device capabilities such as cameras, GPS, accelerometers, and touchscreens. The provider mobile application 142 can operate in online or offline modes, utilizing local storage and caching mechanisms to facilitate functionality when network connectivity is limited. Security measures, such as encryption, authentication, and secure communication protocols, can be implemented to protect user data and ensure privacy.

In some arrangements, the user device 140 and application 142 can be configured to provide one or more interfaces (e.g., graphical user interfaces (GUIs)). For example, the user device 140 and application 142 may generate and provide the following interfaces: an exchange interface/GUI(s) (e.g., for accessing, viewing, or updating exchanges corresponding to a user and a provider), an account interface/GUI(s) (e.g., for accessing, viewing, or updating accounts corresponding to a user, a provider, and various merchants), a reward interface/GUI(s) (e.g., for accessing, viewing, or updating rewards associated with exchanges, providers, and/or merchants), a payment instrument interface (e.g., for viewing or spending with a linked payment instrument (e.g., agnostic transaction card—also referred to herein as a linked payment instrument, linked instrument, agnostic payment instrument, or agnostic instrument)), etc. For example, the exchange interface/GUI(s) can display a history of all recent transactions (e.g., in a table format for a past predefined amount of time), accessing, viewing, and updating exchanges associated with a user’s provider account. In another example, the account interface can include a provider-managed list of linked or unlinked user accounts with various merchants. In various embodiments, the provider can maintain an account (e.g., checking account, savings account, etc.) associated with a user. Further, the user may have additional accounts with other entities, such as third parties (e.g., merchants), and the provider exchange system 110 can link the provider account of the user with various third-party accounts of the user. In yet another example, the reward (or recognition unit) interface can depict a summary of accumulated rewards for users to access, view, and update their rewards earned from transactions with different merchants and the provider. Further, the reward or recognition unit interface can include one or more content items or actionable elements corresponding to allocating (e.g., redeeming) recognition units with various merchants according to various conversion rates (e.g., first exchange parameter, second exchange parameter, etc.). In another example, the payment instrument interface can display a digital linked payment instrument (e.g., content item or actionable element corresponding to an agnostic transaction card or credit card) to facilitate a user viewing or spending the linked payment instrument. In some arrangements, the interfaces can include various additional or alternative content items (e.g., for presenting content) and/or actionable elements (e.g., user-selectable or user-interactive features) and be presented via application 142 presented in a viewport (e.g., viewable window) of mobile electronic device 140.

In some examples, the user device 140 can provide an interface (e.g., from the modeling system 114 of the provider exchange system 110) on a viewport of the user device 140. The viewport refers to a visible area of the graphical user interface through which users can view and interact with user interface content and/or elements. For example, in a mobile application, the viewport displays an initial view of visible content items and/or actionable elements (e.g., menus, forms, data lists, etc.), and users can interact (e.g., scroll or swipe) within the viewport to cause the user device 140 to display an updated view with additional content or elements outside the initial view.

In some examples, the user device 140 can provide an interface (e.g., from the modeling system 114 of the provider exchange system 110) on a viewport of the user device 140. The viewport refers to a visible area of the graphical user interface through which users can view and interact with user interface content and/or elements. For example, in a mobile application, the viewport displays an initial view of visible content items and/or actionable elements (e.g., menus, forms, data lists, etc.), and users can interact (e.g., scroll or swipe) within the viewport to cause the user device 140 to display an updated view with additional content or elements outside the initial view.

The third-party computing system(s) 150 are associated with third-parties relative to the provider institution associated with the provider exchange system 110. As such, the third-parties may include merchants and/or other entities that may provide accounts associated with the user but be maintained by third-parties relative to the provider institution. In some arrangements, the third party computing system(s) 150 can include one or more merchant computing systems of linked merchants (e.g., a merchant computing system of a first linked merchant). For example, the provider exchange system 110 can provide a login interface by accessing the third party computing system 150 (e.g., merchant computing system) using a viewport of a graphical user interface (GUI) of the application 142 of the user device 140. Further, user device 140 can present a login interface from the third party computing system(s) 150 within the application 142 such that the user can enter login credentials (e.g., username, email, phone number, password, passcode, multi-factor authentication input, etc.). Upon successful authentication, the third party computing system(s) 150 can provide an authorization code to the application 142 (e.g., via the network 130), and the application 142 can communicate the authorization code to the provider (e.g., to provider exchange system 110) to complete an account linking process (e.g., facilitating provider access to merchant accounts of a user). Further, a user can view displayed content items and/or interact with input elements (e.g., actionable elements with content) presented on the graphical user interface of the application after accessing or communicating with the third party computing system(s) 150. In some arrangements, data used to update the content items and/or actionable elements can be received via a data communications link (e.g., network 130) between the user device 140 and the third party computing system(s) 150, or via a data communications link between the provider exchange system 110 and third party computing system(s) 150.

The provider exchange system 110 is structured or configured to receive exchange data (e.g., communicated via network 130) including an exchange amount for an exchange initiated by a linked payment instrument. For example, exchange data can include various details or information related to a transaction/exchange, such as an exchange amount or total purchase price (e.g., $20 exchange amount), data associated with one or more linked merchants corresponding to the exchange (e.g., a first merchant, second merchant, etc.), transaction date/time, exchange parameter(s) or exchange rate(s), and more. For example, the provider exchange system 110 can receive or collect one or more exchanges and/or corresponding exchange data (e.g., via the network 130) by interfacing with a merchant computing system (e.g., third party computing system 150). In another example, receiving can include the provider exchange system 110 accessing or using APIs provided by a merchant’s payment gateway, directly from the linked payment instrument provider, or otherwise. In some arrangements, the linked payment instrument can correspond to a plurality of linked merchants of a provider (e.g., the linked merchants and/or associated data being stored in one or more datasets of database 120, received by the provider exchange system 110 from third party computing system(s) 150, etc.). For example, the linked merchants can include a group of partnered or associated entities (e.g., a list of entities) corresponding to the linked payment instrument. For example, each merchant of the linked merchants agrees to an allocation of recognition units earned through exchanges with any of the other linked merchants (e.g., provides redemption opportunities for rewards earned with a different merchant of the linked merchants or merchant group). For example, a rewards credit card (e.g., linked payment instrument) can be linked to a network of partnered stores (e.g., merchants), each participating in a shared loyalty program (e.g., for providing a user with agnostic allocation/redemption opportunities). For example, the linked merchants can be part of a group that shares recognition units, such as rewards points, earned through transactions at any of the merchants in the group. For example, purchasing at a bookstore (e.g., first merchant) can earn points that are redeemable at a linked coffee shop (e.g., second merchant). In some arrangements, the provider exchange system 110 can further generate at least one recognition unit (e.g., rewards credit) corresponding with the exchange amount. For example, generating a recognition unit can include the provider exchange system 110 calculating and issuing points based on the transaction amount and/or merchant-specific criteria or rules. For example, data indicative of a $20 purchase at a grocery store and can further generate 20 reward points/recognition units (assuming a 1 point per dollar exchange rate or conversion rate), and the generated recognition units can be stored for user access (e.g., for spending) in the user’s loyalty account. In some arrangements, the recognition unit can include an allocation state. For example, the allocation state of a recognition unit can be a first state (e.g., unallocated) corresponding to the recognition unit being redeemable, and the allocation state can be updated to a second state (e.g., allocated) responsive to redemption and/or allocation of the recognition unit with a merchant.

In some arrangements, the provider exchange system 110 can determine a first exchange rate for the recognition unit based on at least one first exchange parameter (e.g., conversion rate) of a first linked merchant or group of the plurality of linked merchants and the exchange amount, and a second exchange rate for the recognition unit based on at least one second exchange parameter of a second linked merchant or group of the plurality of linked merchants and the exchange amount. For example, the provider exchange system 110 can determine a first exchange rate by analyzing the spending criteria of a first linked merchant, such as “Fargo Eatery.” Here, the first exchange parameter can be the total amount spent by a user at the first merchant in the past month. For example, if a user has spent over $500 in the last 30 days, the provider exchange system 110 can set or assign a higher exchange rate of 2 reward points per dollar spent, whereas for spending below $500, the rate can be 1.5 points per dollar. That is, determining can include calculating an allocation value or conversion total for the recognition unit by multiplying the exchange amount (e.g., $50 for a transaction by a user) corresponding to an exchange parameter (e.g., 1.5 points for user transactions with a first merchant) of a merchant (e.g., the allocation valve being 1.5 points multiplied by $50 for a total value of $75). The provider exchange system 110 can further calculate various additional and/or alternative exchange rates based on various exchange parameters. In some examples, determining the first and/or second exchange rate can incentivize higher spending with one of the linked merchants by offering better rewards for certain types of customers or users. In another example, the first or second exchange parameter can include an area of business or product category associated with the exchange, such as a merchant type of the first or second merchant (e.g., entertainment merchant, dining category, transportation, etc.) For example, the provider exchange system 110 can determine a different exchange rate based on receiving exchange parameters indicating the exchange involved purchases of a first type of products (e.g., organic products) versus a second type of products (e.g., non-organic products). For example, a first exchange rate of 1.2 points per dollar can be determined for exchanges by the user involving organic goods, and a second exchange rate of 1 point per dollar can be determined for exchanges involving non-organic items (e.g., reflecting a merchant or provider strategy to promote certain products). In another example, the provider exchange system 110 can determine a first or second exchange rate for a first or second linked merchant based on promotional criteria (e.g., participation in a seasonal sale, where the provider exchange system 110 can apply temporary exchange rate based on exchange parameters such as the user’s participation or non-participation), user-specific criteria (e.g., the user’s membership status in a merchant loyalty program, where platinum members can receive an enhanced rate of 2.5 points per dollar spent, while regular members get 1.5 points per dollar), transaction/exchange criteria (e.g., purchase time, purchase amount, etc.), and various additional and/or alternative exchange parameters or rates.

In some arrangements, the provider exchange system 110 can further generate one or more content items or one or more actionable elements corresponding to the first exchange rate and to the second exchange rate. For example, the provider exchange system 110 can create or cause the provider mobile application 142 to create actionable elements, such as interactive buttons labeled “Redeem Now” or “Activate Offer,” that appear in the app’s interface. In some examples, the provider mobile application 142 can provide or generate actionable elements to provide users with immediate options to engage with the current rates by directly applying them to their transactions or redeeming rewards. In some arrangements, the provider exchange system 110 can provide the one or more content items or the one or more actionable elements to a graphical user interface (GUI) of a provider mobile application (e.g., application 142) of the provider. For example, the provider exchange system 110 can deliver or transmit the content items and/or actionable elements to the mobile app utilizing network 130 by pushing updated promotional content (e.g., the updated items/elements) an interface of the provider mobile application 142 , thereby keeping the user engaged with up-to-date reward opportunities. Additionally, the provider exchange system 110 can facilitate the integration of these elements into the app’s existing layout to contextually present promotional content and actionable options in the GUI based on the user’s interactions and/or preferences (e.g., assigning a “favorite” to a frequently-used element). In some arrangements, the provider exchange system 110 can receive a selection (e.g., via application 142 of user device 140) of the one or more content items or the one or more actionable elements corresponding to the first exchange rate or to the second exchange rate. In some arrangements, in response to receiving the selection of the first exchange rate, the provider exchange system 110 can allocate the at least one recognition unit to the first linked merchant. In some arrangements, in response to receiving the selection of the second exchange rate, the provider exchange system can allocate the at least one recognition unit to the second linked merchant. For example, upon a user selecting the first or second exchange rate, the provider exchange system 110 can adjust the user’s points balance (e.g., stored in exchange dataset 122 or account dataset 124) to reflect the points being redeemed at the specified rate (e.g., at the first or second rate depending on the user selection) with a merchant, transfer the correct number of points from the user’s account to the merchant’s account, and/or mark the units as redeemed or “allocated” for the transaction. In some arrangements, the provider exchange system 110 can further update the allocation state of the at least one recognition unit indicating the at least one recognition unit is allocated to the one or more merchants of the plurality of linked merchants. For example, after the points/recognition units are redeemed at the first merchant, the provider exchange system 110 can update the allocation state of the recognition units to show that the units are now allocated to the first merchant and no longer available for use with another merchant. In some arrangements, the allocation of the at least one recognition unit can be agnostic such that points earned with any linked merchant can be redeemed with any other linked merchant (e.g., according to the exchange rate(s)) using application 142.

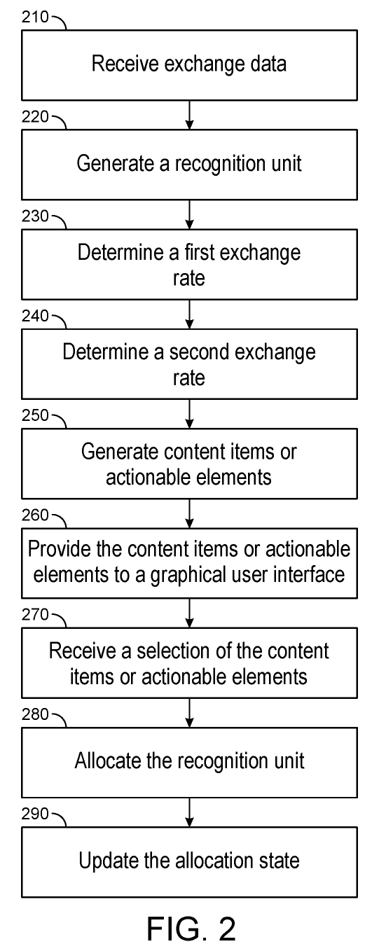

In some arrangements, the provider exchange system 110 includes a plurality of sub-processing systems, shown as the generation system 112, modeling system 114, content system 116, and allocation system 118 for synchronizing accounts and exchanges and/or for incorporating the various features and/or functionalities described herein (e.g., for performing one or more steps of method 200 of FIG. 2). In some arrangements, the generation system 112 can receive exchange data (e.g., from one or more components of FIG. 1 communicating via network 130) including an exchange amount for an exchange initiated by a linked payment instrument. For example, the generation system 112 can receive exchange data such as transaction amounts and merchant details from one or more components (e.g., merchant computing systems or payment gateways) via the network 130. This data can include information like the total purchase amount ($50 at “WF Gym + Spa”), the date and time of the exchange/transaction, and the merchant identifier. In another example, receiving can include the generation system 112 can processing the received exchange data to calculate recognition units by applying the relevant exchange rates stored in the exchange dataset 122 (e.g., a $50 purchase can generate 100 reward points if the exchange rate is 2 points per dollar). In some arrangements, the linked payment instrument can correspond to a plurality of linked merchants of a provider (e.g., stored in one or more datasets of database 120, stored in data sources, etc.). For example, the linked merchants can include partnered entities agreeing to allocations of rewards earned via user exchanges with other linked merchants. In some arrangements, the generation system 112 can further generate at least one recognition unit (e.g., rewards credit) corresponding with the exchange amount and an allocation state. For example, generating can include the generation system 112 creating icons, symbols, text, and/or other content or elements.

In some arrangements, the modeling system 114 can determine a first exchange rate for the at least one recognition unit based on at least one first exchange parameter of a first linked merchant or group of the plurality of linked merchants, and a second exchange rate for the at least one recognition unit based on at least one second exchange parameter of a second linked merchant or group of the plurality of linked merchants. For example, the modeling system 114 can determine that the first exchange rate for the first merchant is 1.5 points per dollar spent if the customer’s monthly spending exceeds $500, and determining further can include the modeling system 114 applying the exchange parameter to the transaction total (e.g., exchange amount) corresponding to the exchange. In some examples, the modeling system 114 can determine the exchange rates based on analyzing customer spending patterns and applying the first exchange parameter related to spending thresholds. In another example, the modeling system 114 can determine a second exchange rate of 2 points per dollar for the second merchant during a seasonal promotion period.

In some arrangements, the content system 116 can further generate one or more content items or one or more actionable elements corresponding to the first exchange rate and to the second exchange rate. For example, the content system 116 can generate digital banners or pop-up notifications within the provider’s mobile application and/or to showcase offers (e.g., “Earn double points at Fargo Eatery this weekend only!” In an example, the content system 116 can dynamically create content items based on the current promotional exchange rates and include visual elements like graphics or logos related to the merchant (e.g., to attract user attention). In another example, the content system 116 can create interactive elements, like buttons labeled “Activate Offer” or “Redeem Now,” which can be displayed on the mobile app’s GUI. In some arrangements, the content system 116 can provide the one or more content items or the one or more actionable elements to a graphical user interface (GUI) of a provider mobile application (e.g., application 142) of the provider. In some arrangements, the content system 116 can receive a selection (e.g., via application 142 of user device 140) of the one or more content items or the one or more actionable elements corresponding to the first exchange rate or to the second exchange rate. For example, if a user selects an option to “Redeem Points at 2x Rate at the second merchant” within the provider mobile application 142, the selection can be communicated back to the provider exchange system 110 through network 130. For example, the content system 116 can process the selection by verifying it against the user’s points balance and/or eligibility criteria to determine that the conditions of the promotional offer are met or satisfied.

In some arrangements, in response to receiving the selection of the first exchange rate or the second exchange rate, the allocation system 118 can allocate the at least one recognition unit to the first linked merchant or the second linked merchant based on the selection. For example, after points or recognition units are redeemed at one or more merchants, the allocation system 118 can update the allocation state of the recognition units (e.g., by modifying data stored in the database 120) to show that these points are now allocated to a merchant and are no longer available for use with other merchants. In some arrangements, the allocation system 118 can further update the allocation state of the at least one recognition unit indicating the at least one recognition unit is allocated to the one or more merchants of the plurality of linked merchants. In some arrangements, the allocation of the at least one recognition unit can be agnostic for at least the first linked merchant and the second linked merchant. That is, units or points earned via exchanges with the first merchant can be redeemed at the second merchant, units or points earned via exchanges with the second merchant can be redeemed (e.g., allocated) at the first merchant. Further, units or points earned via exchanges with any of the plurality of linked merchants can be redeemed with the first merchant or the second merchant, and units or points earned via exchanges with the first merchant or the second merchant can be redeemed with any of the plurality of linked merchants. That is, the allocation system 118 can facilitate redemption independently of where points corresponding to a transaction were initially accumulated (e.g., to facilitate the flexible use of points across different linked merchants within a user or provider network).

Referring now to FIG. 2, a flowchart for a method that can be implemented or performed by one or more components/systems of FIG. 1 is shown, according to some arrangements. At least provider exchange system 110 of FIG. 1 can be configured to perform method 200. In some arrangements, the steps or blocks of method 200 can be executed sequentially or in parallel (e.g., block 220 and block 230 can be performed in parallel). It should be understood that in other embodiments, the steps may be performed in another order, combined, and/or additional modifications implemented, such as the deletion of one or more steps and/or the addition of one or more steps.

In a broad overview of method 200 (implementing the synchronization architecture), at block 210, the provider exchange system 110 can receive exchange data. At block 220, the provider exchange system 110 can generate a recognition unit. At block 230, the provider exchange system 110 can determine a first exchange rate. At block 240, the provider exchange system 110 can determine a second exchange rate. At block 250, the one or more processing circuits can generate content items or actionable elements. At block 260, the one or more processing circuits can provide the content items or actionable elements to a graphical user interface. At block 270, the one or more processing circuits can receive a selection of the content items or actionable elements. At block 280, the provider exchange system 110 can allocate the recognition unit. At block 290, the provider exchange system 110 can update the allocation state.

Generally, in method 200, a provider exchange system (e.g., provider exchange system 110 of FIG. 1) can receive exchange data at block 210. At block 220, the provider exchange system can generate a recognition unit. At block 230, the provider exchange system can determine a first exchange rate. At block 240, the provider exchange system can determine a second exchange rate. At block 250, the provider exchange system, a user device (e.g., user device 140 of FIG. 1), or an application (e.g., provider mobile application 142 of FIG. 1) can generate content items or actionable elements. At block 260, the provider exchange system, user device, or application can provide the content items or actionable elements to a graphical user interface (e.g., displayed on the user device via the application). At block 270, the provider exchange system, user device, or application can receive a selection of the content items or actionable elements. At block 280, the provider exchange system can allocate the recognition unit. At block 290, the provider exchange system can update the allocation state (e.g., by modifying data stored in a data repository, such as database 120 of FIG. 1).

In some arrangements, at block 210, the one or more processing circuits (e.g., provider exchange system 110 in FIG. 1) can receive exchange data. In some arrangements, at block 210, the provider exchange system 110 can receive exchange data including an exchange amount for an exchange initiated by a linked payment instrument. For example, an exchange can include a transaction between one or more of a user, a merchant, and a provider (e.g., a credit card statement payment by a user to a provider, a purchase made with a merchant using a provider-issued transaction card or linked payment instrument). In an example, the provider exchange system 110 can receive exchange data including various information related to transactions (e.g., amounts, parameters, payments, rewards allocations, exchanges, etc.) between a user and one or more linked merchants (e.g., vendors, entities, etc.). In one example, the provider exchange system 110 can receive an exchange amount including an amount or total payment corresponding to an exchange (e.g., an exchange amount of $70 for a payment to a first linked merchant). In some arrangements, receiving can include the provider exchange system 110 determining or identifying a new exchange or exchange data associated with a user account with the provider by receiving data indicating the new exchange (e.g., via a data communications link) or by querying a database storing exchange and/or account data (e.g., database 120 of FIG. 1). In another example, receiving can include the provider exchange system 110 processing or facilitate a new exchange (e.g., between a user and a first merchant) and further receiving data corresponding to the new exchange (e.g., exchange date, exchange amount, etc.). Further, receiving can include the provider exchange system 110 executing an algorithm, such as a machine learning model (e.g., a neural network trained on historical transaction data, a decision tree algorithm classifying transaction types), or a rules-based system (e.g., regular expressions matching transaction attributes, heuristic algorithms comparing transaction metadata) to provide allocation or redemption opportunities to users based on received exchanges/exchange information (e.g., exchange amounts, recognition units, conversion rates/exchange parameters, etc.).

In some arrangements, the linked payment instrument can correspond to a plurality of linked merchants of a provider. That is, a linked payment instrument can include a digital credit card, virtual rewards card, or other digital representation of a provider-issued payment card associated with the provider exchange system 110. In another example, the provider exchange system 110 can provide a linked payment instrument including a physical card (e.g., credit card, loyalty card, etc.) corresponding to digitally stored information (e.g., information for spending using the card, information for allocating recognition units earned through the linked payment instrument, etc.) used for transactions or exchanges. In some examples, the linked payment instruments can be agnostic such that recognition units earned via exchanges with any of the plurality of linked merchants can be redeemed with the first merchant or the second merchant, and recognition units earned via exchanges with the first merchant or the second merchant can be redeemed with any of the plurality of linked merchants.

In some arrangements, at block 220, the one or more processing circuits (e.g., provider exchange system 110) can generate recognition unit(s). In some arrangements, the provider exchange system 110 can generate at least one recognition unit corresponding with the exchange amount and an allocation state. For example, the provider exchange system 110 can create or generate rewards for spending with various merchants through a linked payment instrument (e.g., digital representation of a provider-issued rewards card). For example, the provider exchange system 110 can assign a value (e.g., monetary value) to the recognition unit based on a transaction total (e.g., exchange amount) and whether the rewards have been redeemed (e.g., allocation state). For example, the provider exchange system 110 can create a recognition unit (e.g., data structure with fields such as a value corresponding to 5% of the transaction total and an allocation state field), store the data field and update the allocation state (e.g., allocation state field) based on identifying the exchange corresponds to previously redeemed recognition units. In another example, the provider exchange system 110 can generate recognition unit(s) corresponding to rewards or rewards points redeemable by a user, and the provider exchange system 110 can provide points that are either immediately available for use (e.g., via immediate redemption) or pending allocation (e.g., based on redemption criteria).

In some arrangements, at block 230, the one or more processing circuits (e.g., provider exchange system 110) can determine a first exchange rate. In some arrangements, the provider exchange system 110 can determine a first exchange rate for the at least one recognition unit based on at least one first exchange parameter of a first linked merchant or group of the plurality of linked merchants and the exchange amount. For example, the provider exchange system 110 can determine an exchange amount including a transaction sum, exchange total, or other amount corresponding to the value of the exchange (e.g., a $20 exchange amount for a $20 purchase with the first merchant). For example, the provider exchange system 110 can determine a first exchange parameter including the exchange rate (e.g., 1 pt = 1.5 pts, 1:1.5, etc.) corresponding to an allocation with the first linked merchant, such that recognition units earned with one or more additional merchants of the plurality of merchants can be converted by the provider exchange system 110 according to the first exchange parameter before allocation (e.g., for spending with the first linked merchant). In other examples, the first exchange parameter can include information used by the provider exchange system 110 to determine the exchange rate rather than directly containing the rate information, such as merchant criteria of the linked merchants (e.g., eligibility criteria, spending criteria, etc.), exchange data (e.g., historical transaction logs, credit card spending information, rewards data, etc.), and/or additional information affecting a redemption or exchange rate. In some examples, the exchange rate can include multiple exchange rates (e.g., to provide a dynamic rate) applied according to various criteria. For example, the first exchange rate can include an applied first exchange rate of 1:1.5 for users who have spent less than a qualifying total with the first merchant over a predetermined period of time, an applied first exchange rate of 1:2 for users who have spent more than the qualifying total, and/or various additional or alternative applied rates corresponding to various exchange data or merchant parameters (e.g., related to transaction/exchange dates, types of exchanges, loyalty tier levels, etc.). In another example, determining the first exchange rate can include the provider exchange system 110 determining an adjusted rate based on promotional periods or special events (e.g., holiday sales, merchant anniversaries, etc.) associated with the merchant.

In some arrangements, at block 240, the one or more processing circuits (e.g., provider exchange system 110) can determine a second exchange rate. In some arrangements, at block 240, the provider exchange system 110 can determine a second exchange rate for the at least one recognition unit based on at least one second exchange parameter of a second linked merchant or group of the plurality of linked merchants. In an example, the second exchange rate can be determined by the provider exchange system 110 as described above regarding the first exchange rate. In another example, determining the second exchange rate can include the provider exchange system 110 executing various additional and/or alternative processes, such as evaluating user-specific criteria (e.g., user’s transaction history, loyalty status with the second merchant) to personalize the exchange rate. In another example, determining can include the provider exchange system 110 applying seasonal or event-based adjustments (e.g., higher rates during the merchant’s clearance sale or festive season). That is, the first exchange rate or the second exchange rate can reflect both the general parameters and specific promotional conditions of the second merchant, facilitating variable exchange benefits. For example, the second exchange rate can offer 1:2 points conversion during off-peak shopping hours to incentivize purchases during less busy times, while offering 1:1.8 during peak hours to balance the load on the merchant’s resources. Additionally, the second exchange rate can be influenced by various factors (e.g., the overall economic context, such as inflation rates or changes in consumer behavior trends) and can be updated dynamically by the provider exchange system 110 in response to such external conditions. In some arrangements, the at least one recognition unit being agnostic for at least the first linked merchant and the second linked merchant. That is, the recognition units can be accumulated with one merchant and redeemed with another without restriction based on where they were initially earned. For example, points or rewards units earned through transactions with the first linked merchant can be redeemed with the second linked merchant at the applicable exchange rate, and vice versa. This agnostic behavior allows users to have flexible redemption options across the entire network of linked merchants, promoting user engagement and loyalty across the provider’s ecosystem.

In some arrangements, at block 250, the one or more processing circuits (e.g., provider mobile application 142) can generate content items or actionable elements. In some arrangements, at block 250, the provider mobile application 142 can generate one or more content items or one or more actionable elements corresponding to the first exchange rate and to the second exchange rate. For example, the generating can include the provider mobile application 142 generating or creating non-interactable or informational content items (e.g., static illustrations, content fields, icons, etc.), which can include various information such as exchange history data, recognition unit data, linked merchant data, and/or account data for presenting to the user on the graphical user interface. In another example, the actionable elements can be presented by provider mobile application 142 as interactive buttons on the GUI and include content indicating that the buttons can be interacted with to earn, manage, and/or allocate earned recognition units. In another example, the provider mobile application 142 can generate actionable elements including dropdown menus, checkboxes, or input fields that facilitate the user providing additional information or preferences related to recognition units and/or allocation (e.g., related to selecting merchants for allocation, specifying points quantities for transferring/redeeming, etc.).

In some arrangements, at least one of the one or more content items or the one or more actionable elements generated by provider mobile application 142 corresponds with allocating at least one recognition unit agnostically (e.g., between one or more linked merchants and not corresponding to an initial exchange causing the initial creation/generation of the recognition unit). For example, the provider mobile application 142 can generate or create content items including summaries (e.g., a rewards or recognition unit allocation summary), charts, graphs and other visuals of the user’s recognition unit accumulation and usage trends over time. In another example, provider mobile application 142 can generate or create actionable elements can include sliders, knobs, dials, buttons, and various other user input devices for adjusting various properties of recognition units across various merchants (e.g., elements for allocation or distribution, buttons for initiating instant redemptions, etc.). Additionally, generating can include provider mobile application 142 creating guidance elements (e.g., tutorial or help elements) to guide new users in managing and/or allocating recognition units.

In some arrangements, at block 260, the one or more processing circuits (e.g., provider mobile application 142) can provide the content items or actionable elements to a graphical user interface. In some arrangements, at block 260, the provider exchange system 110 can provide the one or more content items or the one or more actionable elements to a graphical user interface (GUI) of provider mobile application 142 of the provider. For example, providing can include the provider mobile application 142 using a framework to insert the actionable elements into predefined slots within the GUI layout (e.g., using cross-platform mobile development frameworks, declarative UI frameworks, etc.). In another example, the the provider mobile application 142 can update the GUI elements asynchronously via API calls (e.g., using third party or merchant APIs, etc.) and facilitate interface responsiveness during updates. Further, providing can include the provider mobile application 142 employing differential rendering techniques to update only updated or changed elements of the GUI (e.g., virtual DOM diffing, incremental DOM updates, etc.). For example, the actionable elements can be rendered by the provider mobile application 142 as part of a main interface of a GUI of a provider mobile application, and the one or more processing circuits can utilize existing GUI frameworks to dynamically insert the elements into the appropriate locations within the provider application 142. In another example, the actionable elements can be delivered by the provider mobile application 142 through a background update process, where the GUI is refreshed to display the new elements without the user restarting the application to provide exchange and/or account information or actions available in real-time (e.g., instantaneously or substantially instantaneously). In another example, provider exchange system 110 can provide the one or more actionable elements to a non-mobile application of the provider (e.g., a desktop application), and the actionable elements can be provided on a graphical user interface of the non-mobile application (e.g., via an electronic display of a desktop computer of the user).

In some arrangements, at block 270, the one or more processing circuits (e.g., provider mobile application 142) can receive a selection of the content items or actionable elements. In some arrangements, at block 270, the provider mobile application 142 can receive a selection of the one or more content items or the one or more actionable elements corresponding to the first exchange rate or to the second exchange rate. For example, receiving a selection of the actionable elements can include the provider mobile application 142 detecting a user’s interaction with the interactive buttons on the GUI (e.g., a tap or click on a “Redeem Rewards” button, swiping on a touchscreen to select a drop-down item, scanning a scannable code, etc.). In another example, the user can select a redemption element using the GUI, and the provider mobile application 142 can initiate an allocation process in response (e.g., determining an eligible exchange, calculating a number of recognition units for allocation based on an exchange rate, subtracting a first amount from a first user account with a first merchant based on the recognition units, and adding a second amount to a second user account with a second merchant based on the calculated number of recognition units). In another example, receiving can include the provider mobile application 142 capturing input events from various interface components (e.g., dropdown selections, text input submissions, checkbox toggles, etc.). Further, receiving can involve processing gesture-based interactions (e.g., pinch-to-zoom, long press to activate a contextual menu, etc.) to select actionable elements. Additionally, receiving can include the provider mobile application 142 processing voice commands where users can verbally initiate actions such as redeeming points or transferring recognition units between accounts (e.g., in response to a user verbally speaking “Transfer 50 points from X merchant to Y merchant”).

In some arrangements, at block 280, the one or more processing circuits (e.g., provider exchange system 110) can allocate the recognition unit. In some arrangements, at block 280, in response to receiving the selection of the first exchange rate, the provider exchange system 110 can allocate the at least one recognition unit to the first linked merchant or the second linked merchant based on the selection. In some arrangements, at block 280, in response to receiving the selection of the second exchange rate, the provider exchange system 110 can allocate the at least one recognition unit to the second linked merchant. That is, the provider exchange system 110 can receive user input indicative of redemption or allocation with the first linked merchant and apply exchange parameters to the exchange total (e.g., total amount) spent with another merchant (e.g., second linked merchant) such that the at least one recognition unit can be spent with the second linked merchant. Similarly, the provider exchange system 110 can receive user input indicative of a redemption or allocation with the second linked merchant and apply exchange parameters to the exchange total spent with another merchant (e.g., first linked merchant) such that the at least one recognition unit can be spent with the second linked merchant. For example, allocating can include updating the user’s account balance with the first or second merchant to reflect the new allocation of recognition units. For example, if a user selects a number of points from a pharmacy account (e.g., a second merchant) to allocate to a grocery store account (e.g., a first merchant), the provider exchange system 110 can be configured to increase the points balance in the user’s grocery store account by the selected number of points and/or deduct the selected number of points from the user’s pharmacy account. In another example, allocating can involve the provider exchange system 110 converting the recognition units into a merchant-specific currency or credit that can be used for purchases (e.g., converting points into a gift card balance or a promotional code). Additionally, allocating can include the application 142 generating a confirmation message or receipt for the user including exchange or allocation information such as the allocation amount or any remaining balance of recognition units, which can be presented/displayed using a GUI executed on a user device (e.g., user device 140 of FIG. 1).

In some arrangements, at block 290, the one or more processing circuits (e.g., provider exchange system 110) can update the allocation state. In some arrangements, at block 290, the provider exchange system 110 can update the allocation state of the at least one recognition unit indicating the at least one recognition unit is allocated to the one or more merchants of the plurality of linked merchants. For example, updating the allocation state can include provider exchange system 110 marking the recognition unit as redeemed or transferred in the database, ensuring it cannot be double-spent. Additionally, the update can trigger any necessary downstream processes, such as the provider exchange system 110 notifying the merchant of the updated balance or initiating the generation of new recognition units based on the recent activity. For example, after a user allocates points to a specific merchant, the system can automatically generate new recognition units as a reward for reaching a certain spending threshold or participating in a promotional campaign. Further, updating the allocation state can involve provider exchange system 110 synchronizing the user’s updated balance across multiple platforms or devices, ensuring consistency in the user’s account information regardless of how they access it. In another example, the updated allocation state can be used to adjust the user’s eligibility for additional rewards or benefits, such as unlocking higher tiers in a loyalty program or qualifying for exclusive offers.

In some arrangements, the allocation of the at least one recognition unit can be agnostic. In some arrangements, the allocation of the at least one recognition unit can be agnostic for at least the first linked merchant and the second linked merchant. That is, units or points earned via exchanges with the first merchant can be redeemed at the second merchant, units or points earned via exchanges with the second merchant can be redeemed (e.g., allocated) at the first merchant. Further, units or points earned via exchanges with any of the plurality of linked merchants can be redeemed with the first merchant or the second merchant, and units or points earned via exchanges with the first merchant or the second merchant can be redeemed with any of the plurality of linked merchants. In some examples, the allocation system 118 can allocate or redeem recognition units or points independently of the merchant corresponding to a transaction were initially accumulated. For example, a user can earn points through purchases at a grocery store (Merchant A) and redeem those points at a clothing retailer (Merchant B) if the grocery store and the clothing retailer are both “linked merchants” with the provider exchange system 110. In another example, points earned at a gas station (Merchant C) can be used for discounts on electronics at a linked or partnered online store (Merchant D). In some examples, users can pool or aggregate points from multiple merchants and redeem them for a larger reward with another linked merchant (e.g., combining or otherwise redeeming a $20 recognition unit with Merchant A and a $20 recognition unit with Merchant B as a $40 recognition unit with Merchant C).

In some arrangements, the one or more processing circuits (e.g., provider exchange system 110) can further determine a difference between the first exchange parameter and the second exchange parameter. For example, the provider exchange system 110 can calculate a threshold recognition unit value or discount at two different merchants and present the more advantageous option to the user. In some arrangements, determining can include modeling the first exchange parameter to the second exchange parameter. For example, modeling can include simulating various exchange rates to find the most favorable outcome for the user, such as adjusting points-to-currency conversion rates dynamically based on market data (e.g., Forex rates). For example, modeling can include the provider exchange system 110 utilizing various data to predict which merchant will offer the best conversion rate (e.g., modeling data corresponding to exchange rates, Forex rates, etc. over a specified period to identify the highest value). In another example, the highest current amount can be used to present the best deal to the user via the GUI. For example, the best deal can be highlighted on the user’s dashboard or main screen of the provider mobile application, providing the user with updated exchange offers in real-time (e.g., best current exchange offers or conversion rates at different merchants). In some arrangements, determining can include updating, by the provider mobile application 142, the one or more content items or the one or more actionable elements with the difference between the first exchange parameter and the second exchange parameter. For example, the provider mobile application 142 can adjust the displayed conversion rates in real-time based on market fluctuations or other external or internal factors to show a compilation or list of updated conversion rates in the user’s account or rewards summary. In some arrangements, determining can include providing, by the provider mobile application 142, the updated one or more content items or actionable elements to the GUI in a viewport of the provider mobile application. For example, the updated rates can be shown on the user’s dashboard and be highlighted or otherwise marked as the best current exchange offer (e.g., recognition unit offer, conversion rate, etc.) on page/interface of the application.

In some arrangements, the one or more processing circuits e.g., provider exchange system 110) can further receive, from a user device, a request for the linked payment instrument. For example, the user can send a request via the mobile application for a new credit card linked to their rewards account. The request can include user data and payment instrument data. For example, the request can contain the user’s name, address, and current account number. The method can further include identifying, by the provider exchange system 110, the plurality of linked merchants based on the payment instrument data or the user data. For example, the system can identify all merchants where the user’s rewards points are applicable. In some arrangements, identifying can include the provider exchange system 110storing data of the plurality of linked merchants with data for allocating a plurality of recognition units. For example, the provider exchange system 110 can store merchant IDs along with associated points balances. In another example, the stored data can include transaction histories for calculating reward points.

In some arrangements, in response to receiving the request for the linked payment instrument, the one or more processing circuits (e.g., provider exchange system 110 and/or application 142) can generate the linked payment instrument. For example, the provider exchange system 110 can create a new virtual credit card linked to the user’s rewards account, and the provider application 142 can present a digital representation of the virtual credit card via a GUI. In some arrangements, generating can include verifying, by the provider exchange system 110, the request based on the user data and the payment instrument data. For example, verifying can include the one or more processing circuits analyzing or processing the user’s account status and transaction history based on various criteria or prerequisites (e.g., credit score, age or other demographic information, etc.) before issuing a new card. In another example, the provider exchange system 110 can authenticate the request (e.g., using card numbers, user account details, etc.) or otherwise verify the request’s legitimacy and/or accuracy. In some arrangements, the provider exchange system 110 can further generate a digital wallet identifier or a token for digitally linking the payment instrument data with the data of the plurality of linked merchants. For example, the provider exchange system 110 can create a unique token (e.g., NFT, DNFT, or other tokens) that associates the new card with the user’s existing rewards points (or recognition units) across different linked or associated merchants. In some examples, the token generated by the provider exchange system 110 can be stored on a blockchain or other ledger or distributed ledger (e.g., using Distributed Ledger Technology or “DLT”).

In some arrangements, the provider exchange system 110 and/or application 142 can further configure a user device to include the digital wallet identifier or the token. In some arrangements, configuring can include accessing, by the provider exchange system 110, the provider mobile application 142. For example, the one or more processing circuits can establish a connection with the provider mobile application and send and/or receive data to cause the app (or a GUI executing the app) to be updated to display the new virtual card (e.g., in response to the user selecting a “See Card” button or other user input device). In some arrangements, the method can further include storing, by the provider exchange system 110, the digital wallet identifier or the token in a provider data store (e.g., storing data). For example, the provider exchange system 110 can save the token in a secure database managed or accessible to the provider (e.g., as described regarding database 120 of FIG. 1). In some arrangements, the method can further include enrolling, by the one or more processing circuits, the provider mobile application to make (or facilitate) exchanges using the linked payment instrument. For example, enrolling can include creating or linking or establishing a user account with the provider to make exchanges using an account or other data related to the linked payment instrument (e.g., to convert points to currency, to make purchases directly, etc.), and enrolling may further include the provider mobile application facilitating exchanges. In some arrangements, the one or more processing circuits can generate a linked payment instrument element corresponding to the linked payment instrument. For example, in response to a user being enrolled, a visual representation of the new card can be created for display in the app (e.g., as a digitalized or digital linked payment instrument) and include various information or data, such as a card number, issuer or provider information (e.g., name of entity providing the card), and/or exchange/transaction data corresponding to spending/exchanges uses the linked payment instrument.

In some arrangements, the provider exchange system 110 can further establish a data communications link with a merchant computing system of the first linked merchant. For example, establishing can include the provider exchange system 110 linking a merchant system with a provider system or otherwise facilitating communications via a network (e.g., network 130) using various communications protocols (e.g., as described regarding FIGS. 1 and 3). In some arrangements, the provider exchange system 110 can further receive, via the data communications link, the first exchange parameter including data for allocating multiple recognition units of the first linked merchant. For example, the data for allocating the recognition units can include transaction amounts, merchant parameters (e.g., exchange parameters), user information (e.g., wallet addresses, account numbers), and so on. In some arrangements, the one or more processing circuits can map the data for allocating the recognition units to one or more linked payments instruments of the provider. For example, mapping can include the provider exchange system 110 linking, associating, or otherwise mapping allocation data (e.g., card number, exchange total, calculated conversion rate, etc.) to recognition units stored on multiple linked payment instruments (e.g., agnostic transaction cards) of a user with a provider. For example, the provider exchange system 110 can map data of a user’s account with a first merchant (e.g., points total, card number, etc.) to a second merchant such that the second merchant can receive and/or process the data for allocation. In some arrangements, the one or more processing circuits can further provide the linked payment instrument element to the GUI of the provider mobile application. For example, after mapping, the one or more processing circuits can generate or send display data or other data (e.g., to a user device, such as user device 140 of FIG. 1) to facilitate the display of the new card to the user via a “wallet” section or another payment/cards section of the provider application.

In some arrangements, the provider exchange system 110 can identify one or more identified merchants for including with or removing from the plurality of linked merchants. For example, identifying the one or more identified merchants can include the provider exchange system 110 accessing stored data (e.g., stored via database 120 of FIG. 1) corresponding to a list of linked merchants based on a user’s selection of the identified merchants for allocation (e.g., using a user input of a GUI) and/or for other tasks (e.g., for removing or deleting a merchant, for adding a merchant, etc.). For example, the provider exchange system 110 can remove a merchant from a group corresponding to linked instrument based on identifying the merchant disagreeing or revoking agreement to participate in an agnostic redemption program associated with the linked instrument. Further, the provider exchange system 110 can add a new merchant to an agnostic allocation group based on determining the merchant agreeing to participate or partnering, based on a user request, due to incorrect removal, and so on. In some arrangements, the provider exchange system 110 can further provide the content items or actionable elements indicating the one or more identified merchants. In an example, in response to a user being presented with elements for selecting one or more of a first merchant, second merchant, or third merchant for recognition unit allocation and selecting the first merchant, the one or more processing circuits can update the items or elements based on the user’s selection and/or generate or transmit the updated one or more content items or actionable elements to the GUI of the provider mobile application. In some arrangements, the one or more processing circuits can further receive, via the GUI, a selection of the one or more content items or actionable elements corresponding to the one or more identified merchants. For example, receiving can include receiving data transmitted by a user input device indicating the selection of one or more merchants and updating (e.g., including the selected linked merchant name(s) for removing or adding). In some arrangements, the one or more processing circuits can store data corresponding to the one or more identified merchants using a distributed ledger technology (DLT). For example, updates to the merchants’ participation in the rewards program can be logged by provider exchange system 110 on a blockchain to facilitate reliable data storage and/or dynamic access to allocation data for redeeming recognition units.

In some arrangements, determining a difference between the first exchange parameter and the second exchange parameter can further include calculating, by provider exchange system 110, a first amount based on the first exchange parameter and the exchange amount and calculating, provider exchange system 110, a second amount based on the second exchange parameter and the exchange amount. For example, the system can calculate $10 for 1000 points at one merchant and $12 for the same points at another. That is, calculating can include determining the monetary equivalent of points for different merchants. In some arrangements, calculating can further include the one or more processing circuits generating data indicating the monetary equivalent or value for the exchange amount or the exchange parameter to display to the user (e.g., displayed to the user via a GUI of the provider mobile application). In some arrangements, the method can further include modeling, by the one or more processing circuits, the first amount to the second amount to determine a highest amount. For example, modeling can include the provider exchange system 110 utilizing historical data to predict which merchant will offer the best conversion rate (e.g., modeling data corresponding to exchange rates or exchange parameters over a specified period to identify the highest value). In another example, the highest amount can be used to present the best deal to the user via the GUI of application 142. For example, the best deal can be highlighted on the user’s dashboard or main screen of the provider mobile application, providing the user with updated exchange offers in real-time (e.g., best current exchange offers or conversion rates across different merchants of a list of linked merchants).

In some arrangements, the selection can be at least one of an exchange rate selection of the first exchange rate or the second exchange rate, a merchant selection of the first linked merchant or the second linked merchant, or a unit selection of a recognition unit type. For example, an exchange rate selection includes a user’s selection of one or more provided conversion rates (e.g., 1:1.5) for converting unallocated recognition units (e.g., before or as a part of allocation). For example, the user can make an exchange rate selection of a higher conversion rate (e.g., first exchange rate) at a less preferred merchant or a lower rate (e.g., second exchange rate) at a favorite store. For example, the user can make a merchant selection by choosing to allocate points to the first merchant that were previously earned via a qualifying exchange with the second merchant. In another example, the selection can include a unit selection of various types of recognition units (e.g., points, miles, cashback options, etc.). In some arrangements, the one or more processing circuits can further update data corresponding to the selected exchange rate, merchant, or recognition unit type in a provider data store. For example, the selected exchange rate or recognition unit type can be stored in a secure database accessible by the provider, and updating can include appending, adding to, deleting from, modifying, or otherwise adjusting the stored data to indicate the user selection.

In some arrangements, the at least one recognition unit corresponds to at least one of (1) an allocated state, (2) an unallocated state, or (3) an expired state. For example, an allocated state can refer to points already redeemed, an unallocated state can refer to points that are available for use, and an expired state can refer to points that are no longer valid. For example, a recognition unit can be expired such that the recognition unit is ineligible for redemption with partnered merchants, but may have been eligible prior to expiration (e.g., with the unit assigned to expire at a time and/or based on various conditions). In some arrangements, updating from the unallocated state to the allocated state can further include storing, by the one or more processing circuits, data corresponding to the update from the unallocated state to the allocated state in a provider data store. For example, storing can include recording a redemption of points in the user’s transaction history or another location accessible by a provider or provider mobile application. In some arrangements, the method can further include updating, by the one or more processing circuits, the one or more content items or actionable elements indicating the update from the unallocated state to the allocated state. For example, the app can show the updated points balance immediately after redemption. In some arrangements, one or more processing circuits can provide the updated one or more content items or actionable elements to the GUI of the provider mobile application. For example, providing can include sending or transmitting updated content items or actionable elements (e.g., based on the selection) via a data communications link to the GUI for display to the user.

In some arrangements, the allocation is agnostic based on the first linked merchant initiating the exchange, and the selection being the second exchange rate for the second linked merchant. For example, points earned at a grocery store (e.g., first merchant) can be redeemed (e.g., for a better rate) at a clothing store (e.g., second merchant) based on an exchange rate corresponding to the clothing store without any further preference or restriction for where the points were earned. In some arrangements, the allocation is agnostic based on the second linked merchant initiating the exchange, and the selection being the first exchange rate for the first linked merchant. For example, points earned at a gas station (e.g., second merchant) can be allocated for use at a restaurant (e.g., first merchant) with an exchange rate corresponding to the restaurant (or exchange parameter, conversion rate, etc.) that benefits the user regardless of the earning source (e.g., without reference to the initial exchange causing the initial generation or allocation of recognition units).

In some arrangements, the provider exchange system 110 can receive exchange data including an exchange amount for an exchange initiated by a linked payment instrument, wherein the linked payment instrument corresponds to a plurality of linked merchants of a provider. For example, the provider exchange system 110 can pull 100 miles from Airline X as a redemption, convert the 100 miles to points for Merchant A, and facilitate the user redeeming or allocating the points at Merchant A. In another example, the linked partners can be predefined or selectable, affecting aspects such as APR and redemption rates. Further, the provider exchange system 110 can generate rewards credits corresponding with the exchange amount and determine a first exchange rate for the exchange amount based on at least one first exchange parameter of a first linked merchant or group of linked merchants. For example, the user interface can depict redemption rates in real-time, facilitating the user to choose the merchant with the highest redemption rate. The provider exchange system 110 can also determine a second exchange rate for the exchange amount based on at least one second exchange parameter of a second linked merchant or group of linked merchants. Additionally, the application 142 can generate one or more content items or actionable elements corresponding to the first and second exchange rates and provide these to a graphical user interface (GUI) of a provider mobile application. In response to receiving a selection of the actionable elements, the provider exchange system 110 can allocate the rewards credits based on the selected exchange rate and update the allocation state of the rewards credits to indicate they are allocated to one or more merchants of the merchant group.

Referring now to FIG. 3, block diagram illustrating an example computing system 300 suitable for use in the various arrangements described herein is shown. The computing system 300 can represent the provider exchange system 110, database 120, user devices 140, third party computing systems 150, and/or various other example computing systems described herein. FIG. 3 is a block diagram illustrating an example computing system suitable for use in the various arrangements described herein, according to some arrangements. The computing system 300 includes a bus 305 or other communication component for communicating information and a processor 310 coupled to the bus 305 for processing information. The computing system 300 also includes main memory 315, such as a random-access memory (RAM) or other dynamic storage device, coupled to the bus 305 for storing information, and instructions to be executed by the processor 310. Main memory 315 can also be used for storing position information, temporary variables, or other intermediate information during execution of instructions by the processor 310. The computing system 300 can further include a read only memory (ROM) 320 or other static storage device coupled to the bus 305 for storing static information and instructions for the processor 310. A storage device 325, such as a solid-state device, magnetic disk, or optical disk, is coupled to the bus 305 for persistently storing information and instructions.

The computing system 300 can be coupled via the bus 305 to a display 335, such as a liquid crystal display, or active-matrix display, for displaying information to a user. An input device 330, such as a keyboard including alphanumeric and other keys, can be coupled to the bus 305 for communicating information, and command selections to the processor 310. In another arrangement, the input device 330 has a touch screen display 335. The input device 330 can include any type of input device, such as a biometric sensor, a cursor control, such as a mouse, a trackball, or cursor direction keys, for communicating direction information and command selections to the processor 310 and for controlling cursor movement on the display 335.

In some arrangements, the computing system 300 can include a communications adapter 340, such as a networking adapter. Communications adapter 340 can be coupled to bus 305 and can be configured to facilitate communications with a computing or communications network 130 and/or other computing systems. In various illustrative arrangements, any type of networking configuration can be achieved using communications adapter 330, such as wired (e.g., via Ethernet), wireless (e.g., via Wi-Fi, Bluetooth), satellite (e.g., via GPS) pre-configured, ad-hoc, LAN, WAN.

According to various arrangements, certain processes that effectuate illustrative arrangements that are described herein can be achieved by the computing system 300 in response to the processor 310 executing an arrangement of instructions contained in main memory 315. Such instructions can be read into main memory 315 from another computer-readable medium, such as the storage device 325. Execution of the arrangement of instructions contained in main memory 315 causes the computing system 300 to perform the illustrative processes described herein. One or more processors in a multi-processing arrangement can also be employed to execute the instructions contained in main memory 315. In alternative arrangements, hard-wired circuitry can be used in place of or in combination with software instructions to implement illustrative arrangements. Thus, arrangements are not limited to any specific combination of hardware circuitry and software.

Although an example processing system has been described in FIG. 3, arrangements of the subject matter and the functional operations described in this specification can be carried out using other types of digital electronic circuitry, or in computer software (e.g., application, blockchain, distributed ledger technology or DLT) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 3 as singular, stand-alone devices, one of ordinary skill in the art will appreciate that, in some arrangements, the computing system 300 can include virtualized systems and/or system resources. For example, in some arrangements, the computing system 300 can be a virtual switch, virtual router, virtual host, virtual server. In various arrangements, computing system 300 can share physical storage, hardware, and other resources with other virtual machines. In some arrangements, virtual resources of the network 130 (e.g., network 130 of FIG. 1) can include cloud computing resources such that a virtual resource can rely on distributed processing across more than one physical processor, distributed memory, etc.

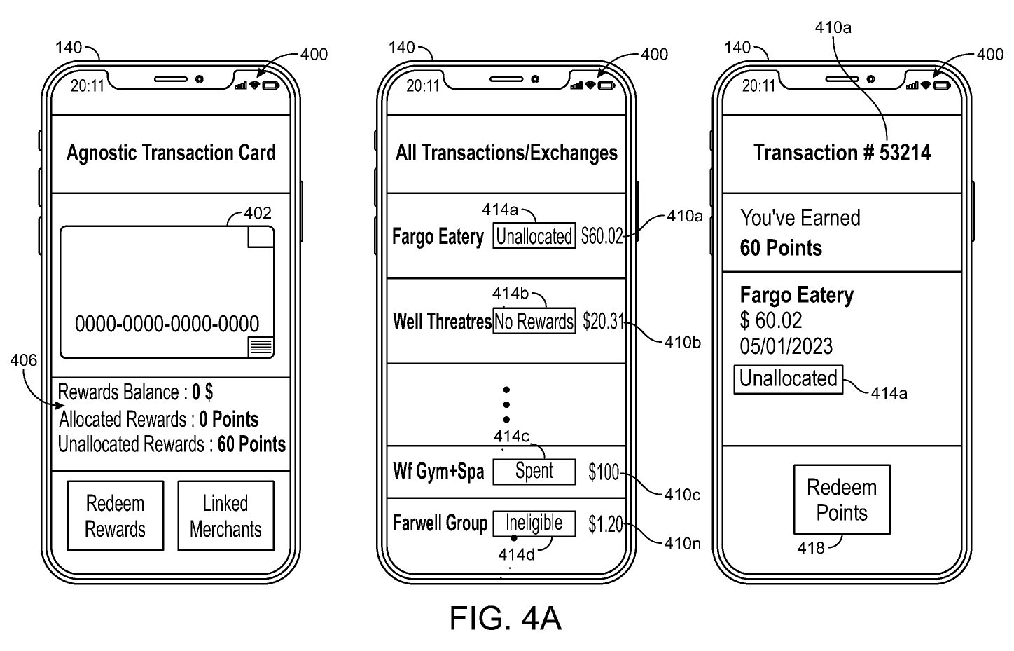

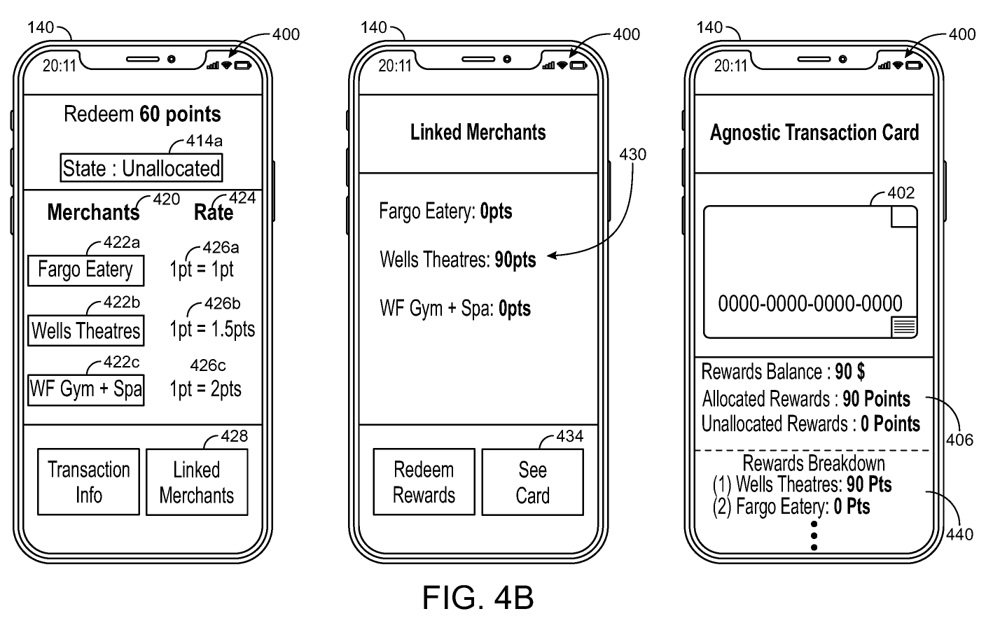

Referring now to FIGS. 4A-4B, example graphical user interfaces depicting an application user interface 400 are shown, according to some arrangements. In general, the application user interface 400 (or “graphical user interface 400,” “GUI 400,” etc.) facilitates synchronization and/or linking of exchanges or accounts between a user, a provider, and one or more merchants. In some arrangements, the graphical user interface 400 is provided by a user device (e.g., mobile device 140 of FIG. 1), via a client or user application provided and supported by a mobile computing system (i.e., as a downloaded application configured to execute or run on the client or user device). In other arrangements, the graphical user interface 400 is provided (e.g., by user device 140, exchange system 110 of FIG. 1) as a hosted website and is accessible by the user device via a network (e.g., network 130 of FIG. 1).

In some arrangements, the graphical user interface 400 facilitates the allocation or redemption of recognition units (e.g., rewards, credits, points, etc.) by a user with one or more linked merchants or a provider. In some arrangements, the interactive elements (e.g., actionable element, input field, content item, etc.) can receive an input, via an electronic device 140, and be updated as the user inputs (or interacts) with the interactive element. In various arrangements, various pages (e.g., exchange pages, point redemption pages, etc.) can be displayed by graphical user interface 400 and can include an individual interface such as a first application user interface, a second application interface, a third application interface, and so on.

Referring now to FIG. 4A, the graphical user interface 400 can provide or display one or more content items and/or actionable elements via the user device 140. In some arrangements, the GUI 400 can include content items and/or actionable elements corresponding to an agnostic transaction card (e.g., linked payment instrument). For example, as shown in FIG. 4A, the GUI 400 can include a digital payment instrument item 402 and recognition unit data 406. In some examples, the digital payment instrument item 402 can include a digital or virtual representation (e.g., icon, illustration, NFT, etc.) of the linked payment instrument (e.g., linked transaction card used to accrue agnostic recognition units by exchanging). In another example, the recognition unit data 406 can include a rewards balance item (e.g., recognition unit balance such as “0 $”, total credits, etc.), an allocated rewards item (e.g., credited rewards, spent rewards, assigned recognition units, etc.), and/or an unallocated rewards item (e.g., unspent credits, unassigned recognition units, etc.). The GUI 400 can further include various additional and/or alternative content items (e.g., data fields, information, illustrations, icons, etc.) and/or actionable elements (e.g., user inputs, buttons, selectable fields, icons, illustrations, etc.), such as a “Redeem Rewards” element or button for allocating, spending, or redeeming recognition units and/or a “Linked Merchants” element or button for viewing, updating (e.g., adding or removing), and/or accessing linked or connected merchants (e.g., partnered merchants for agnostic allocation/redemption). In some arrangements, the user can interact with the various content items and/or actionable elements to perform various functions and/or to access or view various pages (e.g., transactions page, redemption page, etc.) displayed by the GUI 400.

Still referring to FIG. 4A, the graphical user interface 400 can include content items and/or actionable elements corresponding to a list of transactions or exchanges (e.g., all transactions/exchanges between a user and one or more linked merchants facilitated by a provider) displayed on the user device 140. For example, as shown in FIG. 4A, the GUI 400 can include exchanges 410a-410n (collectively, exchanges 410) and allocation states 414a-414n (collectively, allocation states 414). For example, the exchange 410a can include a merchant name (e.g., “Fargo Eatery”), allocation state 414a (e.g., “Allocated” or “Unallocated), exchange amount (e.g., transaction balance, total cost, currency spent, etc.), and/or various additional and/or alternative content fields and actionable elements. In one particular example, the GUI 400 may correspond to a mobile banking application, and the list of transactions/exchanges may be a list of purchases or payments corresponding to transaction card activity (e.g., credit card activity). In some arrangements, the allocation states 414 include data entries or stored data corresponding to recognition units associated with the exchange 410a being allocated (e.g., as shown in allocation state 414b of exchange 410b), unallocated (e.g., as shown in allocation state 414c of exchange 410c), or expired. In other arrangements, allocation states 414 can include various additional or alternative states, conditions, or statuses corresponding to the exchanges 410 or to recognition units created or generated based on one or more of the exchanges 410, such as a “spent” allocation state (e.g., corresponding to recognition units already allocated, redeemed, and/or spent by the user, as shown on allocation state 414c of exchange 410c) and/or an “ineligible” allocation state (e.g., corresponding to an exchange not eligible for earning recognition units, as shown on allocation state 414n of exchange 410n). In some arrangements, the user can interact with (e.g., provide user input to) one or more content items or actionable elements to cause the GUI to provide an output (e.g., list of exchanges, detailed exchange information, etc.) or display a different page. For example, in response to the user interacting with (e.g., clicking, selecting, pressing, etc.) one of the allocation states 414 (e.g., allocation state 414a) or the corresponding exchange 410 (e.g., exchange 410a), the GUI 400 can display a detailed transaction page with information and/or various user inputs related to a specific transaction selected.

Still referring to FIG. 4A, the graphical user interface 400 can include content items and/or actionable elements corresponding to one or more of the exchanges 414 (e.g., content items and/or actionable elements for viewing exchange parameters, other exchange data, or recognition unit data corresponding to a specific transaction included in the list of all transactions) displayed on the user device 140. For example, as shown in FIG. 4A, the GUI 400 can include the transaction 410a and associated information, such as an transaction/exchange identifier or ID (e.g., “Transaction # 53214”), an exchange reward or recognition unit item (e.g., “You’ve earned 60 points”), and transaction/exchange details (e.g., exchange amount of “$60.02,” exchange date of 05/01/2023, etc.). For example, the GUI 400 can include the allocation state 414a (e.g., “unallocated”) to provide (e.g., to a user) the status of recognition units that have not been assigned to be spendable with a merchant (e.g., “60 points” of unallocated recognition units). For example, the recognition units are spendable with the merchant associated with the initial transaction by which the recognition units were earned (e.g., points earned with a first merchant can be automatically redeemable with the first merchant), and in another example, the GUI 400 facilitates the allocation of recognition units before the units are spendable (e.g., earned units can be allocated before being capable of redemption with an exchange). In some arrangements, the GUI 400 can further include various additional and/or alternative content items or user input features, such as a redemption element 418 (e.g., “Redeem Points” button). For example, in response to the user interacting with (e.g., clicking, selecting, pressing, etc.) the allocation state 414a or the redemption element 418, the GUI 400 can display an additional page with information for allocating at least one recognition unit (e.g., 60 points) earned through the exchange 410a.

Referring now to FIG. 4B, the graphical user interface 400 can provide or display (e.g., in response to the user selecting the redemption element 418 of FIG. 4A) one or more content items and/or actionable elements corresponding to allocating (e.g., redeeming) recognition units associated with an exchange via the user device 140. For example, the GUI 400 can include the available amount of unallocated recognition units (e.g., shown as “60 points” in FIG. 4B), the allocation state 414a (e.g., similar to allocation state 414a of FIG. 4A), a list of merchants 420, one or more linked merchants 422a-422c (collectively, linked merchants 422), a list of conversion rates or exchange rates 424, and one or more conversion rates or exchange rates 426a-426c (collectively, exchange rates 426). As illustrated, each of the conversion rates or exchange rates 426a-426c may be distinct and correspond to one of the merchants 422a-422c, and each (or some) of the conversion rates or exchange rates 426a-426c may be different. For example, the list of merchants 420 can include a first merchant 422a (e.g., Fargo Eatery), a second merchant 422 (e.g., Wells Theatres), a third merchant 422c (e.g., WF Gym + Spa), and/or various additional merchants (not shown). In some arrangements, the merchants are linked (e.g., linked merchants, partnered entities, etc.) and a user can agnostically redeem points earned with one of the merchants 422 (e.g., via purchases) with any of the individual merchants 422a-424c. In another example, each of the merchants 422 in the list of merchants 420 can be associated with one or more of the exchange rates 426 in the list of exchange rates 424. That is, the first merchant 422a can correspond to a first exchange rate 426a, the second merchant 422b can correspond to a second exchange rate 426b, and the third merchant 422c can correspond to a third exchange rate 426c. For example, the second merchant 422b can include the second exchange rate 426b of 1 pt = 1.5 pts, such that points or recognition units earned via exchanges with various merchants other than the second merchant 422b (e.g., the first merchant 422a, the third merchant 422c) can be redeemed or allocated for spending with the second merchant 422b according to the conversion/exchange rate 426b.

For example, if 60 points (e.g., a recognition unit with a value of 60 points, multiple recognition units totaling 60 points, etc.) are earned via purchases with the first merchant 422a, the GUI 400 can determine the quantity or amount of points or recognition units to allocate to the second merchant 422b multiplying the 60 points earned with the first merchant 422a by the second conversation rate 426b (e.g., 60 points x 1.5 points, for an allocation of 90 points for performing exchanges with/redeemable with the second merchant 422b). In some arrangements, the user can interact with various actionable elements of the GUI 400 to allocate the points/recognition units with the various merchants 422. In some arrangements, the GUI 400 can include additional actionable elements, such as a “Transaction Info” element (e.g., for displaying a list of transaction as shown in FIG. 4A, for displaying detailed information on a single transaction as shown in FIG. 4A, etc.) or a linked merchants element 428 (e.g., “Linked Merchants” button for viewing an allocation summary to one or more of the linked merchants). For example, the user can interact with content/actionable elements including the allocation state 414a, the merchants 422, and/or the exchange rates 426 to cause the GUI 400 to perform various operations (e.g., allocating recognition units, deallocating units, determining eligibility or an eligible state, displaying a results page or linked merchants page, etc.). For example, in response to the user interacting with (e.g., clicking, selecting, pressing, etc.) the linked merchants element 428, the GUI 400 can display an additional page with information corresponding to an allocation of the recognition unit, as further described herein.

Still referring to FIG. 4B, the graphical user interface 400 can include content items and/or actionable elements corresponding to an allocation of recognition units (e.g., allocation information or summaries, rewards data, etc.) displayed on the user device 140. For example, as shown in FIG. 4A, the GUI 400 can include an allocation summary 430. The allocation summary 430 can include various content fields and or actionable elements corresponding to a rewards allocation between one or more of the linked merchants. For example, the allocation summary 430 can include a listing of all linked merchants (e.g., Fargo Eatery, Wells Theatres, WF Gym + Spa, etc.) and recognition unit information corresponding to allocated or unallocated recognition units with each of the linked merchants. For example, in response to the user selecting the second merchant 422b and/or second exchange rate 426b for allocating the 60 points, the GUI 400 can provide an allocation total (e.g., total points, assigned credits, etc.) for each of the linked merchants 422. For example, if a user selects 60 points earned with the first merchant 422a for allocation with the second merchant 422b as described above, the GUI 400 can provide the allocation summary 430 including an allocation total of 0 points for the first merchant 422a (e.g., corresponding to all points earned with the first merchant 422a being unallocated), 90 points for the second merchant 422b (e.g., corresponding to the 90 points determined by multiplying the unallocated recognition units of the first merchant 422a by the exchange rate 426b), and 0 points for the third merchant 422c (e.g., corresponding to a lack of points/recognition units, the units being previously allocated and spent, the exchange/merchant being ineligible for recognition earnings, etc.).

In some arrangements, the GUI 400 can modify or update the allocation summary 430 in response to receiving data indicating an allocation of one or more recognition units (e.g., in response to the user selecting the second merchant 422b for redemption, as described above). In some arrangements, the GUI 400 can further include various additional and/or alternative content items or user input features, such as a “Redeem Points” element (e.g., button for redeeming additional rewards by returning the user to a previous page) and/or a linked payment instrument element 434 (e.g., “See Card” button for accessing a display corresponding to a linked payment instrument with linked merchants 422). For example, in response to the user interacting with (e.g., clicking, selecting, pressing, etc.) the linked payment instrument element 434, the GUI 400 can display or provide content items and/or actionable elements corresponding to an agnostic transaction card (e.g., linked payment instrument).

Still referring to FIG. 4B, the graphical user interface 400 can provide or display one or more content items and/or actionable elements via the user device 140 (e.g., in response to the user selecting the linked payment instrument element 434). In some arrangements, the GUI 400 can provide or include content items and/or actionable elements containing updated information and/or user inputs related to the agnostic transaction card or linked payment instrument. For example, as shown in FIG. 4B, the GUI 400 can include the digital payment instrument item 402 and recognition unit data 406, and each item or element can include updated data corresponding to an allocation of recognition units earned using the linked payment instrument. For example, the recognition unit data 406 can be updated, modified, appended to, deleted from, or otherwise altered to include an updated rewards balance item (e.g., recognition unit balance such as “0 $”, total credits, etc.), an updated allocated rewards item (e.g., credited rewards, spent rewards, assigned recognition units, etc.), and/or an updated unallocated rewards item (e.g., unspent credits, unassigned recognition units, etc.). The GUI 400 can further include various additional and/or alternative content items (e.g., data fields, information, illustrations, icons, etc.) and/or actionable elements (e.g., user inputs, buttons, selectable fields, icons, illustrations, etc.), such as a “Redeem Rewards” element or button for allocating, spending, or redeeming recognition units and/or a “Linked Merchants” element or button for viewing, updating, and/or accessing linked or connected merchants, as described regarding FIG. 4A.

The embodiments described herein have been described with reference to drawings. The drawings illustrate certain details of specific embodiments that implement the systems, methods and programs described herein. However, describing the embodiments with drawings should not be construed as imposing on the disclosure any limitations that can be present in the drawings.

It should be understood that no claim element herein is to be construed under the provisions of 35 U.S.C. § 112(f), unless the element is expressly recited using the phrase “means for.”

As used herein, the term “circuit” can include hardware structured to execute the functions described herein. In some embodiments, each respective “circuit” can include machine-readable media for configuring the hardware to execute the functions described herein. The circuit can be embodied as one or more circuitry components including, but not limited to, processing circuitry, network interfaces, peripheral devices, input devices, output devices, sensors, etc. In some embodiments, a circuit can take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” can include any type of component for accomplishing or facilitating achievement of the operations described herein. For example, a circuit as described herein can include one or more transistors, logic gates (e.g., NAND, AND, NOR, OR, XOR, NOT, XNOR), resistors, multiplexers, registers, capacitors, inductors, diodes, wiring, and so on.

The “circuit” can also include one or more processors communicatively coupled to one or more memory or memory devices. In this regard, the one or more processors can execute instructions stored in the memory or can execute instructions otherwise accessible to the one or more processors. In some embodiments, the one or more processors can be embodied in various ways. The one or more processors can be constructed in a manner sufficient to perform at least the operations described herein. In some embodiments, the one or more processors can be shared by multiple circuits (e.g., circuit A and circuit B can comprise or otherwise share the same processor which, in some example embodiments, can execute instructions stored, or otherwise accessed, via different areas of memory). Alternatively or additionally, the one or more processors can be structured to perform or otherwise execute certain operations independent of one or more co-processors. In other example embodiments, two or more processors can be coupled via a bus to enable independent, parallel, pipelined, or multi-threaded instruction execution. Each processor can be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors can take the form of a single core processor, multi-core processor (e.g., a dual core processor, triple core processor, quad core processor), microprocessor, etc. In some embodiments, the one or more processors can be external to the apparatus, for example the one or more processors can be a remote processor (e.g., a cloud based processor). Alternatively or additionally, the one or more processors can be internal and/or local to the apparatus. In this regard, a given circuit or components thereof can be disposed locally (e.g., as part of a local server, a local computing system) or remotely (e.g., as part of a remote server such as a cloud based server). To that end, a “circuit” as described herein can include components that are distributed across one or more locations.

An exemplary system for implementing the overall system or portions of the embodiments can include a general purpose computing devices in the form of computers, including a processing unit, a system memory, and a system bus that couples various system components including the system memory to the processing unit. Each memory device can include non-transient volatile storage media, non-volatile storage media, non-transitory storage media (e.g., one or more volatile and/or non-volatile memories), etc. In some embodiments, the non-volatile media can take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media can take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device can be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, can include any type of input device including, but not limited to, a keyboard, a keypad, a mouse, joystick or other input devices performing a similar function. Comparatively, the term “output device,” as described herein, can include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein can show a specific order and composition of method steps, it is understood that the order of these steps can differ from what is depicted. For example, two or more steps can be performed concurrently or with partial concurrence. Also, some method steps that are performed as discrete steps can be combined, steps being performed as a combined step can be separated into discrete steps, the sequence of certain processes can be reversed or otherwise varied, and the nature or number of discrete processes can be altered or varied. The order or sequence of any element or apparatus can be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure can be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or can be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions can be made in the design, operating conditions and embodiment of the embodiments without departing from the scope of the present disclosure as expressed in the appended claims.

What is claimed is:

1. A method for linking instruments, the method comprising:
receiving, by one or more processing circuits, exchange data comprising an exchange amount for an exchange initiated by a linked payment instrument, wherein the linked payment instrument corresponds to a plurality of linked merchants of a provider;
generating, by the one or more processing circuits, at least one recognition unit corresponding with the exchange amount, the at least one recognition unit comprising an allocation state;
determining, by the one or more processing circuits, a first exchange rate for the at least one recognition unit based on at least one first exchange parameter of a first linked merchant or group of the plurality of linked merchants and the exchange amount;
determining, by the one or more processing circuits, a second exchange rate for the at least one recognition unit based on at least one second exchange parameter of a second linked merchant or group of the plurality of linked merchants and the exchange amount, the at least one recognition unit being agnostic for at least the first linked merchant and the second linked merchant;
generating, by the one or more processing circuits, one or more content items or one or more actionable elements corresponding to the first exchange rate and to the second exchange rate;
providing, by the one or more processing circuits, the one or more content items or the one or more actionable elements to a graphical user interface (GUI) of a provider mobile application of the provider;
receiving, by the one or more processing circuits, a selection of the one or more content items or the one or more actionable elements corresponding to the first exchange rate or to the second exchange rate;
in response to receiving the selection corresponding to the first exchange rate, allocating, by the one or more processing circuits, the at least one recognition unit to the first linked merchant;
in response to receiving the selection corresponding to the second exchange rate, allocating, by the one or more processing circuits, the at least one recognition unit to the second linked merchant; and
updating, by the one or more processing circuits, the allocation state of the at least one recognition unit indicating the at least one recognition unit is allocated to the one or more merchants of the plurality of linked merchants.

2. The method of claim 1, further comprising:
determining, by the one or more processing circuits, a difference between the first exchange parameter and the second exchange parameter, wherein determining comprises modeling the first exchange parameter to the second exchange parameter;
updating, by the one or more processing circuits, the one or more content items or the one or more actionable elements with the difference between the first exchange parameter and the second exchange parameter; and
providing, by the one or more processing circuits, the updated one or content items or actionable elements to the GUI in a viewport of the provider mobile application.

3. The method of claim 1, further comprising:
establishing, by the one or more processing circuits, a data communications link with a merchant computing system of the first linked merchant;
receiving, by the one or more processing circuits and via the data communications link, the first exchange parameter comprising data for allocating a plurality of recognition units of the first linked merchant; and
mapping, by the one or more processing circuits, the data for allocating the plurality of recognition units to a plurality of linked payment instruments of the provider.

4. The method of claim 1, further comprising:
receiving, by the one or more processing circuits from a user device, a request for the linked payment instrument, wherein the request comprises user data and payment instrument data; and
identifying, by the one or more processing circuits, the plurality of linked merchants based on the payment instrument data or the user data, wherein identifying comprises storing data of the plurality of linked merchants with data for allocating a plurality of recognition units.

5. The method of claim 4, further comprising:
in response to receiving the request for the linked payment instrument, generating, by the one or more processing circuits, the linked payment instrument, wherein generating comprises:
verifying, by the one or more processing circuits, the request based on the user data and the payment instrument data; and
generating, by the one or more processing circuits, a digital wallet identifier or a token for digitally linking the payment instrument data and with the data of the plurality of linked merchants.

6. The method of claim 5, further comprising:
configuring a user device to comprise the digital wallet identifier or the token by:
accessing, by the one or more processing circuits, the provider mobile application;
storing, by the one or more processing circuits, the digital wallet identifier or the token in a provider data store; and
enrolling, by the one or more processing circuits, the provider mobile application facilitating exchanges using the linked payment instrument;
generating, by the one or more processing circuits, a linked payment instrument element corresponding to the linked payment instrument; and
providing, by the one or more processing circuits, the linked payment instrument element to the GUI of the provider mobile application.

7. The method of claim 1, further comprising:
identifying, by the one or more processing circuits, one or more identified merchants for including with or removing from the plurality of linked merchants;
updating, by the one or more processing circuits, the one or more content items or actionable elements indicating the one or more identified merchants;
providing, by the one or more processing circuits, the updated one or more content items or actionable elements to the GUI of the provider mobile application;
receiving, by the one or more processing circuits via the GUI, a selection of the one or more content items or actionable elements corresponding to the one or more identified merchants; and
updating, by the one or more processing circuits, data corresponding to the one or more identified merchants using a distributed ledger technology (DLT).

8. The method of claim 1, wherein determining a difference between the first exchange parameter and the second exchange parameter further comprises:
calculating, by the one or more processing circuits, a first amount based on the first exchange parameter and the exchange amount;
calculating, by the one or more processing circuits, a second amount based on the second exchange parameter and the exchange amount; and
modeling, by the one or more processing circuits, the first amount to the second amount to determine a highest amount.

9. The method of claim 1, wherein the selection is at least one of:
an exchange rate selection of the first exchange rate or the second exchange rate;
a merchant selection of the first linked merchant or the second linked merchant; or
a unit selection of a recognition unit type.

10. The method of claim 1, wherein at least one recognition unit corresponds to at least one of (1) an allocated state, (2) an unallocated state, or (3) an expired state, and wherein updating from the unallocated state to the allocated state comprises:
storing, by the one or more processing circuits, data corresponding to the update from the unallocated state to the allocated state in a provider data store;
updating, by the one or more processing circuits, the one or more content items or actionable elements indicating the update from the unallocated state to the allocated state; and
providing, by the one or more processing circuits, the updated one or more content items or actionable elements to the GUI of the provider mobile application.

11. The method of claim 1, wherein the allocation is agnostic based on:
the first linked merchant initiating the exchange, and the selection being the second exchange rate for the second linked merchant; or
the second linked merchant initiating the exchange, and the selection being the first exchange rate for the first linked merchant.

12. A system for linking instruments, the system comprising:
one or more processing circuits configured to:
receive exchange data comprising an exchange amount for an exchange initiated by a linked payment instrument, wherein the linked payment instrument corresponds to a plurality of linked merchants of a provider;
generate at least one recognition unit corresponding with the exchange amount, the at least one recognition unit comprising an allocation state;
determine a first exchange rate for the recognition unit based on at least one first exchange parameter of a first linked merchant or group of the plurality of linked merchants and the exchange amount;
determine a second exchange rate for the recognition unit based on at least one second exchange parameter of a second linked merchant or group of the plurality of linked merchants and the exchange amount, the at least one recognition unit being agnostic for at least the first linked merchant and the second linked merchant;
generate one or more content items or one or more actionable elements corresponding to the first exchange rate and to the second exchange rate;
provide the one or more content items or the one or more actionable elements to a graphical user interface (GUI) of a provider mobile application of the provider;
receive a selection of the one or more content items or the one or more actionable elements corresponding to the first exchange rate or to the second exchange rate;
in response to receiving the selection corresponding to the first exchange rate, allocate the at least one recognition unit to the first linked merchant; and
in response to receiving the selection corresponding to the second exchange rate, allocate the at least one recognition unit to the second linked merchant;
update the allocation state of the at least one recognition unit indicating the at least one recognition unit is allocated to the one or more merchants of the plurality of linked merchants.

13. The system of claim 12, wherein the one or more processing circuits are further configured to:
determine a difference between the first exchange parameter and the second exchange parameter, wherein determining comprises modeling the first exchange parameter to the second exchange parameter;
update the one or more content items or the one or more actionable elements with the difference between the first exchange parameter and the second exchange parameter; and
provide the updated one or content items or actionable elements to the GUI in a viewport of the provider mobile application.

14. The system of claim 12, wherein the one or more processing circuits are further configured to:
establish a data communications link with a merchant computing system of the first linked merchant;
receive the first exchange parameter comprising data for allocating a plurality of recognition units of the first linked merchant; and
map the data for allocating the plurality of recognition units to a plurality of linked payment instruments of the provider.

15. The system of claim 12, wherein the one or more processing circuits are further configured to:
receive, from a user device, a request for the linked payment instrument, wherein the request comprises user data and payment instrument data; and
identify the plurality of linked merchants based on the payment instrument data or the user data, wherein identifying comprises storing data of the plurality of linked merchants with data for allocating a plurality of recognition units.

16. The system of claim 12, wherein the one or more processing circuits are further configured to:
calculate a first amount based on the first exchange parameter and the exchange amount;
calculate a second amount based on the second exchange parameter and the exchange amount; and
model the first amount to the second amount to determine a highest amount.

17. The system of claim 12, wherein the selection is at least one of:
an exchange rate selection of the first exchange rate or the second exchange rate;
a merchant selection of the first linked merchant or the second linked merchant; or
a unit selection of a recognition unit type.

18. The system of claim 12, wherein the at least one recognition unit corresponds to at least one of (1) an allocated state, (2) an unallocated state, or (3) an expired state, and wherein the one or more processing circuits are further configured to, in updating from the unallocated state to the allocated state:
store data corresponding to the update from the unallocated state to the allocated state in a provider data store;
update the one or more content items or actionable elements indicating the update from the unallocated state to the allocated state; and
provide the updated one or more content items or actionable elements to the GUI of the provider mobile application.

19. One or more non-transitory computer-readable media (CRM) having instructions stored thereon that, when executed by one or more processing circuits, cause the one or more processing circuits to:
receive exchange data comprising an exchange amount for an exchange initiated by a linked payment instrument, wherein the linked payment instrument corresponds to a plurality of linked merchants of a provider;
generate at least one recognition unit corresponding with the exchange amount, the at least one recognition unit comprising an allocation state;
determine a first exchange rate for the at least one recognition unit based on at least one first exchange parameter of a first linked merchant or group of the plurality of linked merchants and the exchange amount;
determine a second exchange rate for the at least one recognition unit based on at least one second exchange parameter of a second linked merchant or group of the plurality of linked merchants and the exchange amount, the at least one recognition unit being agnostic for at least the first linked merchant and the second linked merchant;
generate one or more content items or one or more actionable elements corresponding to the first exchange rate and to the second exchange rate;
provide the one or more content items or the one or more actionable elements to a graphical user interface (GUI) of a provider mobile application of the provider;
receive a selection of the one or more content items or the one or more actionable elements corresponding to the first exchange rate or to the second exchange rate;
in response to receiving the selection corresponding to the first exchange rate, allocate the at least one recognition unit to the first linked merchant;
in response to receiving the selection corresponding to the second exchange rate, allocate the at least one recognition unit to the second linked merchant; and
update the allocation state of the at least one recognition unit indicating the at least one recognition unit is allocated to the one or more merchants of the plurality of linked merchants.

20. The one or more non-transitory CRM of claim 19, wherein the allocation is agnostic based on:
the first linked merchant initiating the exchange, and the selection being the second exchange rate for the second linked merchant; or
the second linked merchant initiating the exchange, and the selection being the first exchange rate for the first linked merchant.
